(19) United States
(12) Patent Application Publication
(10) Pub. No.: US 2013/0232006 A1
(43) Pub. Date: Sep. 5, 2013

(54) Filtered Search Query Data for Context and User Intent within a Location-Based Search Engine

(71) Applicants: Tim Holcomb, Mission Viejo, CA (US); Mark Goddard, Rancho Santa Margarita, CA (US); Gopal Venkatraman, Irvine, CA (US); Ming Hao Bi, Tianjin (CN); Xiao Bin Gao, Tianjin (CN)

(72) Inventors: Tim Holcomb, Mission Viejo, CA (US); Mark Goddard, Rancho Santa Margarita, CA (US); Gopal Venkatraman, Irvine, CA (US); Ming Hao Bi, Tianjin (CN); Xiao Bin Gao, Tianjin (CN)

(21) Appl. No.: 13/783,732

(22) Filed: Mar. 4, 2013

Related U.S. Application Data
(60) Provisional application No. 61/606,718, filed on Mar. 5, 2012.

(51) Int. Cl. G06F 17/30

(52) U.S. Cl. CPC G06F 17/30864
USPC 705/14.54; 707/706

(57) ABSTRACT

A single search system that returns relevant search results for a user search query by identifying user intent and context implied therein. The inventive system supports POI and address searches initiated from a single search box only. Search query data is input in to a single search box on a single search client to initiate a search for an arbitrary piece of data. Meta-data concerning a nature of a search is not provided to the single search system. A search servlet on a single search server uses an ordered series of filter methods to progressively extract specific aspects of user intent from a freeform search query, and accumulate intent information within a context shared by all filters. The single search system determines a data corpus to search based on context provided in a user search query. Relevant search results are returned to the single search client in a search response.

The present invention claims priority from U.S. Provisional No. 61/606,718, filed Mar. 5, 2012, entitled “Filtered Search Query Data for Context and User Intent within a Location-Based Search Engine”; and from U.S. Provisional No. 61/727,485, filed Nov. 16, 2012, entitled “Single Search Box Global”, the entirety of both of which are expressly incorporated herein by reference.

### BACKGROUND OF THE INVENTION

1. Field of the Invention

This invention relates generally to communications. More particularly, it relates to location-based services and local searching including address.

2. Background of the Related Art

Conventional location-based services (e.g. maps.google.com and naveq.com) typically support one or more text input fields (i.e. a search boxes) within which a user may input a search query for a point of interest (POI), address, etc. Some conventional location-based services search user search query data for matches across one specific corpus, based on non-natural vocabulary (e.g. non-natural syntax/keywords) embedded in a user search query. Moreover, other conventional location-based services search user search query data on a blind term for term basis for matches across all data corpuses, either serially or in parallel.

Unfortunately, when all terms embedded in a user search query are searched against all data corpuses, a results set is unlikely to be returned within an acceptable threshold of time. Moreover, blind searches performed against all data corpuses occasionally return results from more than one corpus which must be ordered in some arbitrary manner (most notably not in order of relevance against a single reference) before returned to a user.

Searching user search query data across multiple independent data sources often fails to result in a determination of a location reference. For instance, searching user search query, “pizza Chicago Ill.”, for matches across multiple corpuses, likely returns an abundance of false positives, being that many pizza restaurants have the term ‘Chicago’ embedded in their place name. An over abundance of false positives returned in a results set is likely to overwhelm good matches returned therewith.

### SUMMARY OF THE INVENTION

A method and apparatus for filtering search query data for context and user intent within a location based search engine, comprises a single search system. The inventive single search system generates and returns relevant search results for a user search query by identifying user intent and context implied therein. In accordance with the principles of the present invention, the single search system returns relevant search results for a user search query, even in the absence of accompanying meta-data, e.g., meta-data identifying a search query as a POI query, an address query, etc. The present invention pertains to POI and address searches initiated from a single search box only.

In accordance with the principles of the present invention, the single search system uses an ordered series of filter methods to progressively extract specific aspects of user intent from a freeform search query, and to accumulate intent information within a context shared by all filters.

The single search system determines a data corpus to search when there are multiple data corpuses to choose from, based specifically upon context provided in a user search query.

In accordance with the principles of the present invention, user search query data (not exceeding 255 characters) is input into a single search box on a single search client (i.e. a client application) to initiate a single search for an arbitrary piece of data (provided that arbitrary piece of data is maintained in a data set supported by the single search system). Meta-data concerning a nature of a search is not provided to the single search system.

In accordance with the principles of the present invention, single search functionality is provided to the single search client via an inventive search servlet on a single search server. In particular, the single search client sends a search query to the single search server to request relevant search results for each single search initiated thereon. A search query received on the single search server is forwarded to the search servlet, and the search servlet retrieves and returns relevant search results to the single search client.

In accordance with the principles of the present invention, the single search system additionally supports advanced suggestion capabilities. In particular, suggestions are displayed on the single search client as a search query is input, character by character, into the single search box. Selection of a suggestion initiates a single search on that suggestion item.

In accordance with the principles of the present invention, the single search system additionally supports existing premium placement ad functionality. In particular, the single search server returns a premium placement ad with each set of local search results returned to the single search client. The single search system uses an existing integrated logistics analysis program to track and store impressions and interactions of users with premium placement ads.

### BRIEF DESCRIPTION OF THE DRAWINGS

Features and advantages of the present invention become apparent to those skilled in the art from the following description with reference to the drawings:

FIG. 1 depicts an exemplary single search box available on a main application screen of a single search client, in accordance with the principles of the present invention.

FIG. 2 depicts an exemplary single search box available on a map screen of a single search client, in accordance with the principles of the present invention.

FIG. 3 depicts an exemplary single search box available on an enter an address screen of a single search client, in accordance with the principles of the present invention.

FIG. 4 depicts an exemplary single search box available on a find a place screen of a single search client, in accordance with the principles of the present invention.

FIG. 5 depicts an exemplary network structure used to provide single search functionality, in accordance with the principles of the present invention.

FIG. 6 illustrates exemplary single search support provided by a search servlet on a single search server, in accordance with the principles of the present invention.

FIG. 7 depicts an exemplary display of search results on a single search client, in accordance with the principles of the present invention.

FIG. 8 depicts exemplary display of suggestions on a single search client, in accordance with the principles of the present invention.

FIG. 9 portrays exemplary display of recent searches on a single search client, in accordance with the principles of the present invention.

FIG. 10 depicts a user interface flow that demonstrates an exemplary single search behavior, in accordance with the principles of the present invention

FIG. 11 shows an exemplary call flow demonstrating a search query and a search reply for a local search, in accordance with the principles of the present invention.

FIG. 12 shows an exemplary call flow demonstrating a search query and a search reply with suggestion functionality, in accordance with the principles of the present invention.

FIG. 13 portrays an exemplary call flow demonstrating a search query and a search reply for a selected POI suggestion, in accordance with the principles of the present invention.

FIG. 14 depicts an exemplary context filtering sequence, in accordance with the principles of the present invention.

FIG. 15 depicts an exemplary logic flow for accepting uber (Location Match) results, in accordance with the principles of the present invention.

FIG. 16 depicts exemplary behavior of search results on the single search client, in accordance with the principles of the present invention.

FIG. 17 depicts an exemplary find a place results screen, in accordance with the principles of the present invention.

FIG. 18 depicts an exemplary enter an address results screen, in accordance with the principles of the present invention.

FIG. 19 portrays a call flow depicting an exemplary single search via automatic speech recognition (ASR), in accordance with the principles of the present invention.

FIG. 20 depicts an exemplary de-duplication mechanism used to remove duplicate POIs from source data, in accordance with the principles of the present invention.

### DETAILED DESCRIPTION OF ILLUSTRATIVE EMBODIMENTS

The present invention comprises a single search system that generates and returns relevant search results for a user search query by identifying user intent and context implied therein. In accordance with the principles of the present invention, the single search system returns relevant search results for a user search query, even in the absence of accompanying meta-data, e.g., meta-data identifying a search query as a POI query, an address query, etc. In particular, the single search system permits users to search POI and address data via a single search box, without indicating a type of search, e.g. POI search, address search, etc. The present invention pertains to POI and address searches initiated from a single search box only, and is preferably used in combination with location based search engines.

In accordance with the principles of the present invention, the single search system generates and returns relevant search results for a user search query by identifying user intent implied therein. User intent is identified by examining constituent parts of a user search query. In particular, the single search system uses an ordered series of filter methods to progressively extract specific aspects of user intent from a freeform search query, and to accumulate intent information within a context shared by all filters.

For instance, given user search query, “pizza but Chicago Ill.”, the single search system is able to determine that a requesting user is searching for a specific type of restaurant, ‘pizza hut’, and that the requesting user has provided a specific location reference, ‘Chicago, Ill.’, about which to search.

The inventive single search system determines which data corpus to search when there are multiple data corpuses to choose from, based specifically upon context provided in a user search query.

Conventional search systems used in conjunction with navigation services, location based services, mobile search services, etc., typically require a search type (e.g., POI search, address search, etc.) for each search query entered in to a search field. However, the single search system does not require a search query to be uniquely identified as a POI search query or an address search query. Rather, the single search system permits users to simply enter an arbitrary search string in to an inventive single search box (i.e. text input field) to initiate a search.

The inventive single search box is a standalone text input field (i.e. not paired with a ‘where’ field) within which a user may input a search query (e.g., in one disclosed embodiment is not to exceed 255 characters, though any length input is within the principles of the invention) to initiate a single search for an arbitrary piece of data (provided that arbitrary piece of data is maintained in a data set supported by the single search system). In accordance with the principles of the present invention, users access a single search box via a single search client (i.e. a client application). More particularly, the single search box is preferably available on a main application screen (i.e. a home screen, carousel view or map view), a map screen, an enter an address screen, and a find a place screen on the single search client.

In accordance with the principles of the present invention, the single search system additionally supports advanced suggestion capabilities. In particular, the single search system returns search suggestions as a user enters a search query in to the single search box.

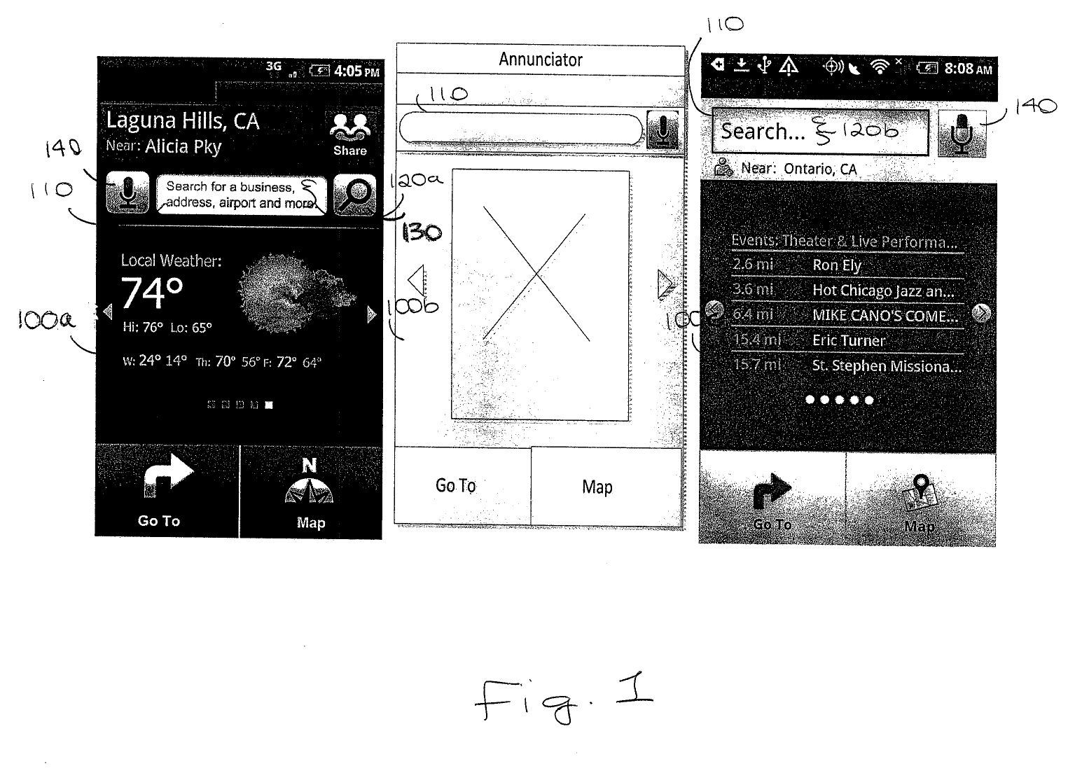

FIG. 1 depicts an exemplary single search box available on a main application screen on a single search client, in accordance with the principles of the present invention.

In particular, FIG. 1 depicts three exemplary main application screens 100a-100c, each of which displays a single search box 110.

As depicted in FIG. 1, a search button (i.e. a button that initiates a single search when pressed) 130 is preferably positioned next to the single search box 110 and the single search box 110 preferably comprises a helper text 120 e.g., ‘Search’ or ‘Search for a Business, Address, Airport, and More’, etc. An automatic speech recognition (ASR) button (i.e. a button to initiate a single search via ASR) 140 is also preferably positioned next to the single search box, as depicted in FIG. 1.

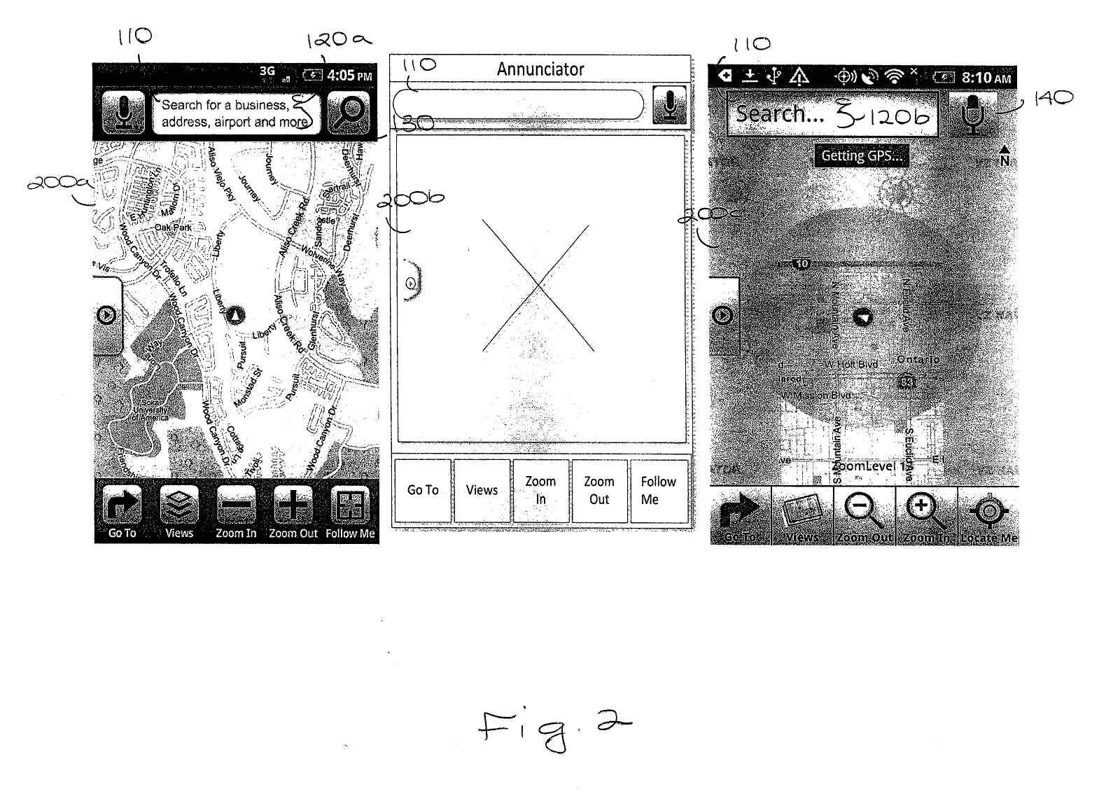

FIG. 2 depicts an exemplary single search box available on a map screen on a single search client, in accordance with the principles of the present invention.

In particular, FIG. 2 depicts three exemplary map screens 200a-200c, each of which displays a single search box 110.

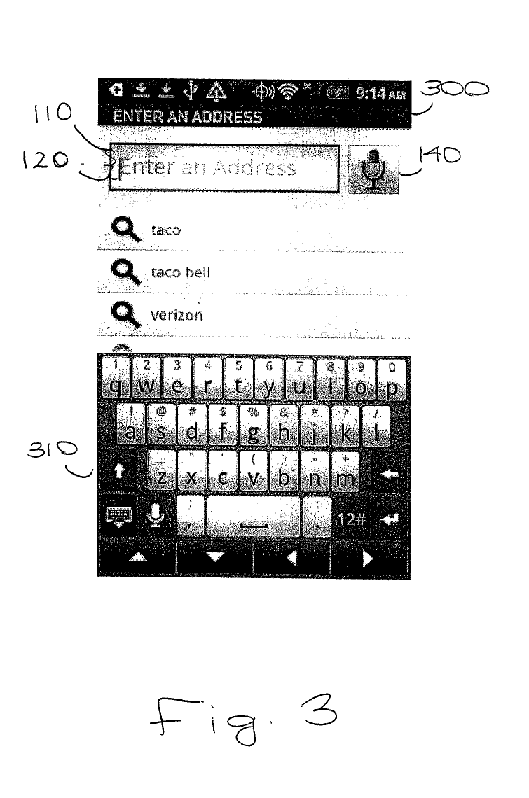

FIG. 3 depicts an exemplary single search box available on an enter an address screen on a single search client, in accordance with the principles of the present invention.

In particular, FIG. 3 depicts an exemplary single search box 110 displayed on the enter an address screen 300 on the single search client. The enter an address screen 300 depicted in FIG. 3 additionally displays a keyboard 310. A keyboard 310 is presented on the single search client when focus (a cursor) is placed inside the single search box 110. A helper text 120 on the enter an address screen 300 preferably reads, ‘Enter an Address’.

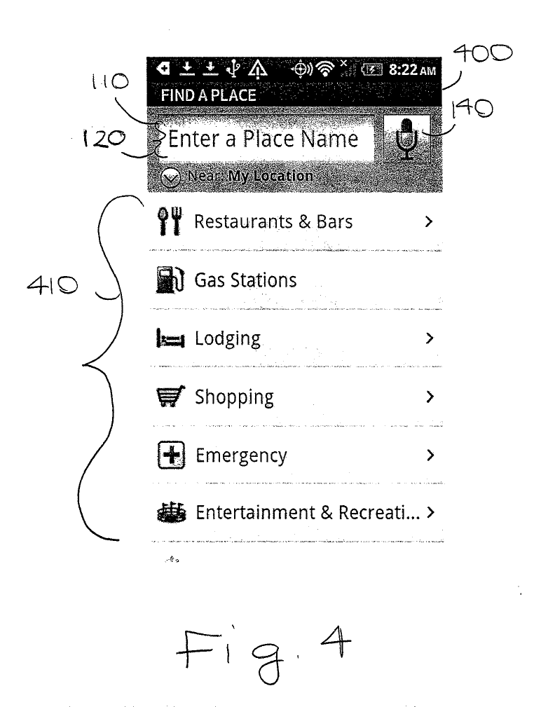

FIG. 4 depicts an exemplary single search box available on a find a place screen on a single search client, in accordance with the principles of the present invention.

In particular, FIG. 4 depicts an exemplary single search box 110 and an exemplary category list 410 displayed on the find a place screen 400 on the single search client. A helper text 120 on the find a place screen 400 preferably reads, ‘Enter a Place Name’.

Single search functionality is provided to the single search client via a search servlet on a single search server.

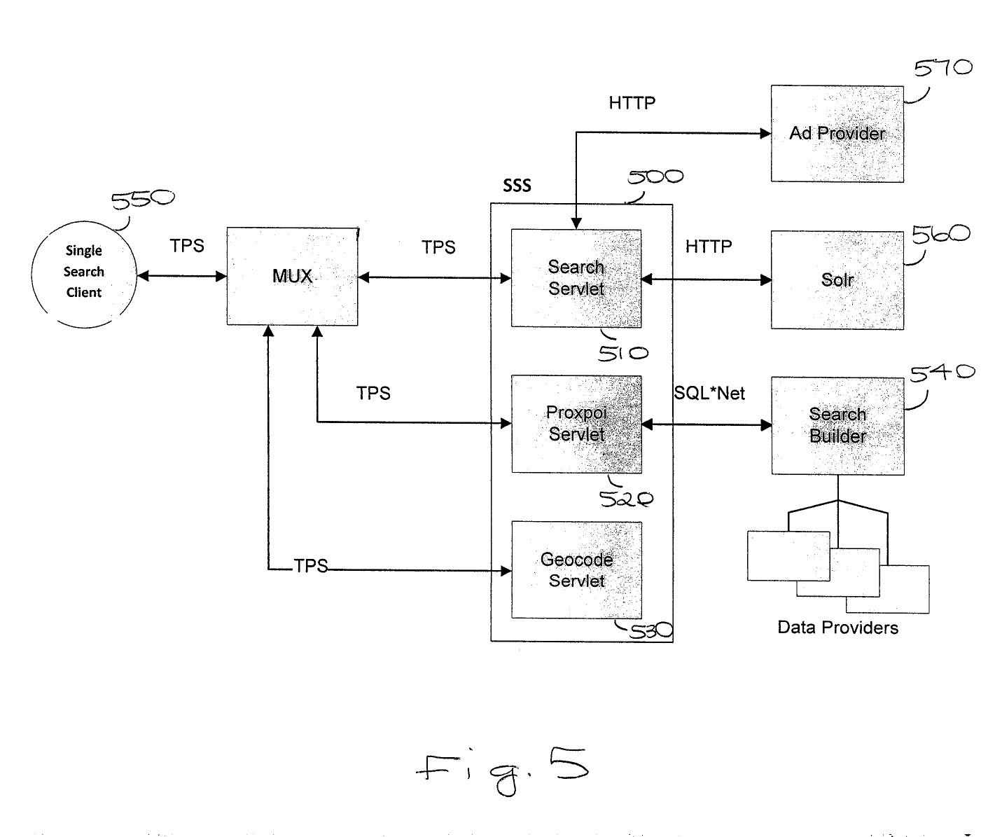

FIG. 5 depicts an exemplary network structure used to provide single search functionality, in accordance with the principles of the present invention.

In particular, the single search client 550 interacts with the single search server 500 to request search results for single searches initiated thereon.

As depicted in FIG. 5, a single search server 500 comprises an inventive search servlet 510 (specific to user search queries), an existing proxpoi servlet 520 (interfacing with an existing SearchBuilder engine 540), and an existing geocode servlet 530. Single search results are handled by the search servlet 510 on the single search server 500.

To retrieve search results for a single search request, the search servlet 510 interfaces with an existing open source Apache Solr™ engine 560, as portrayed in FIG. 5. Apache Solr™ 560 (an Apache Foundation project) is a feature rich, scalable, and well-supported (through an active development company) standalone search platform that provides full text search, database integration, geospatial search, etc.

In accordance with the principles of the present invention, the search servlet 510 also returns advertisements in response to certain single search requests. To retrieve advertisements, the search servlet 510 interfaces with an ad provider 570 (e.g. Navteq ad provider), as shown in FIG. 5.

The single search client 550 sends a search query to the single search server 500 for each single search initiated thereon. Search queries received on the single search server 500 are handled by the search servlet 510. In response to a search query, the search servlet 510 returns relevant search results to the single search client 550, whereupon results are subsequently displayed.

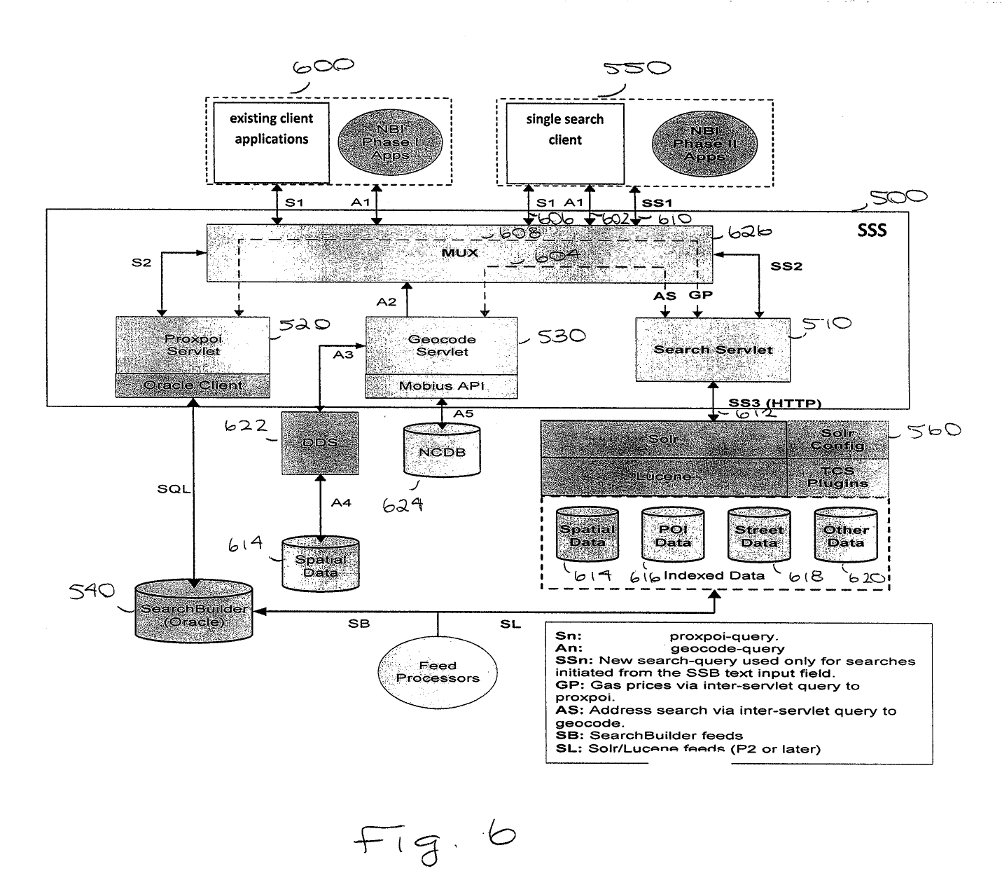

FIG. 6 illustrates exemplary single search support provided by a search servlet on a single search server, in accordance with the principles of the present invention.

As depicted in FIG. 6, single search functionality is provided to the single search client 550 via the inventive search servlet 510, whereas existing client applications 600 are supported by an existing proxpoi servlet 520.

In particular, when a conventional address search query 602 is received on the single search server 500, a multiplexor 626 on the single search server 500 forwards the address search query to the inventive search servlet 510. The inventive search servlet then transmits an interservlet query 604 to the existing geocode servlet 530 (which accesses a map database, in this case the NAVBuilder Core Database (NCDB) 624 and a spatial data database 616) for appropriate geocode query results. Similarly, when a conventional gas price query 606 is received on the single search server 500, the multiplexor 626 on the single search server 500 forwards the gas price search query to the inventive search servlet 510. The inventive search servlet 510 then transmits an interservlet query 608 to the existing proxpoi servlet 520 (which is referencing searchbuilder 540) for appropriate gas price query results. The search servlet 510 returns geocode search results and gas price search results to the single search client 550, whereupon results are subsequently displayed.

Moreover, when a search query for a single search 610 is received on the single search server 500, the multiplexor 626 on the single search server 500 forwards the search query to the inventive search servlet 510. The inventive search servlet 510 then submits an HTTP single search query 612 to the existing Apache Solr™ engine 560 (which is preferably referencing a Apache Lucent™ search library 626) for relevant search results. In response, Apache Solr™ 560 returns relevant data (i.e. spatial data 614, POI data 616, street data 618 and/or any other relevant data 620) to the requesting search servlet 510. The search servlet 510 then returns a search response with relevant search results to the single search client 550, and results are subsequently displayed thereon.

A single search can take several forms and may be initiated in several ways. The present invention comprises several potential use cases.

For instance, in one potential use case, a search query is input in to the single search box 110 and the search button 120 positioned next to the single search box 110 (or an ‘enter’ key on a keyboard 310) is pressed. When a search is initiated via the search button 120 (or an ‘enter’ key), the single search client 550 sends a search query (comprising the user search query entered in to the single search box 110) to the single search server 500 to request relevant search results. In response to the search query, the inventive search servlet 510 generates and returns relevant search results to the single search client 550, whereupon results are subsequently displayed.

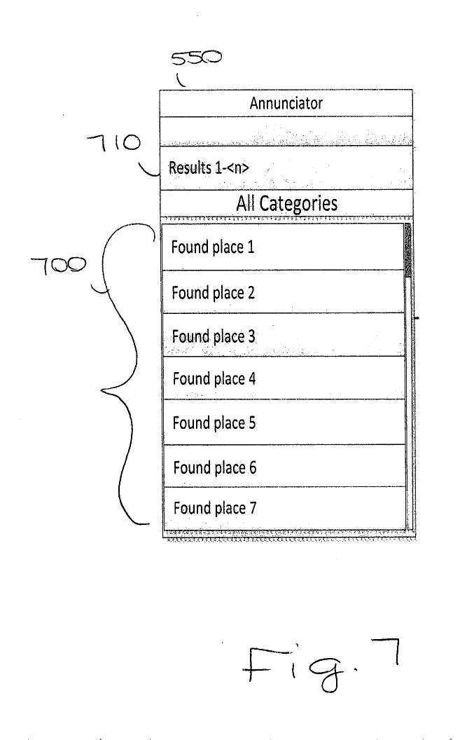

FIG. 7 depicts an exemplary display of search results on a single search client, in accordance with the principles of the present invention.

As depicted in FIG. 7, a list of search results 700 relevant to a user search query is displayed on a results screen 710 on the single search client 550. The single search client 550 is able to request up to 10 (configurable) search results at a time. If more than 10 search results are available for a search query, an existing scroll model is used to display results on a single page.

When search is initiated via the search button 120, search query data is completely freeform and capable of prompting any type of search. Hence, a single search initiated by selection of the search button 120 provides no hint as to type of search (e.g. address search, POI search, etc.) to the single search server 500.

If a search query is sent to the single search server 500 when a data connection is unavailable, a conventional ‘data connection unavailable’ error is displayed on the single search client 550.

In another potential use case, a user begins typing characters in to the single search box 110 on one of a main application screen 100, an enter an address screen 300, or a find a place screen 400. Text input in the single search box 110 prompts the single search client 550 to send a suggestion query to the single search server 500 for suggestion data. While a user is typing, the single search client 550 displays suggestions containing potential matches from client-side data and potential matches generated on the single search server 500, under the single search box 110. A suggestion may represent one or more of the following items: a POI, a partial address, an airport, or a POI category.

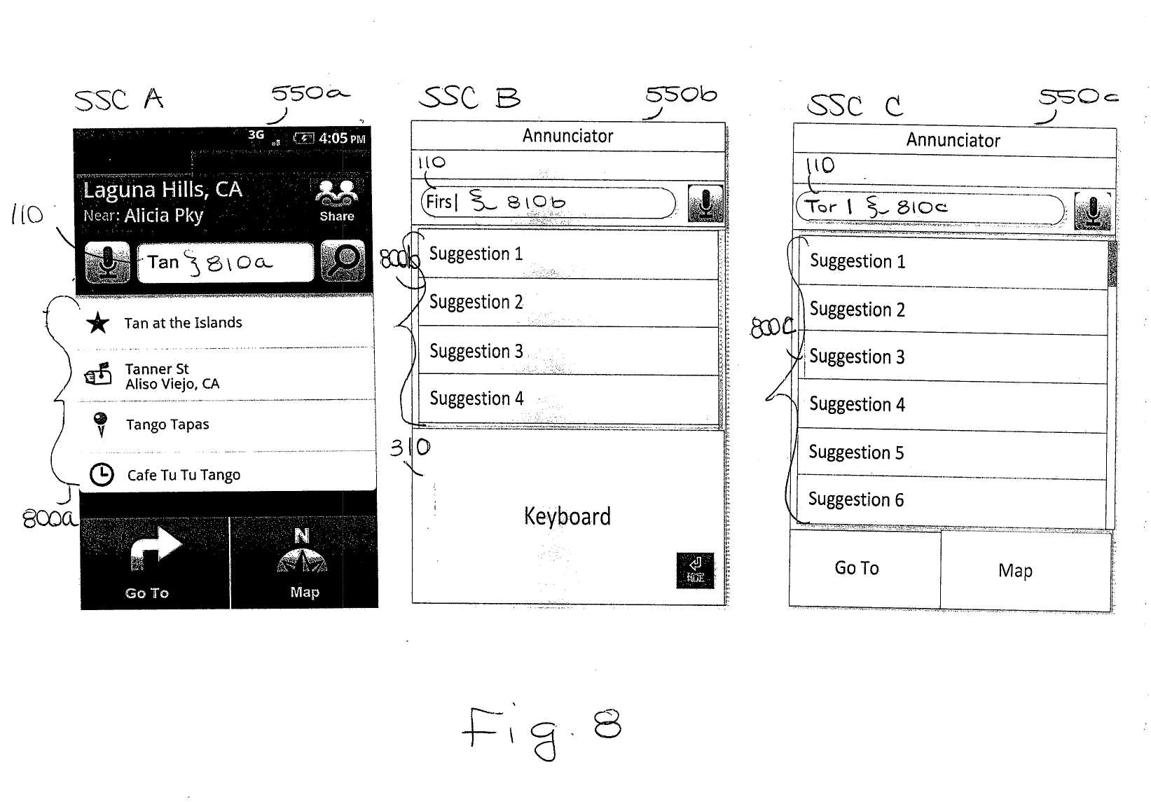

FIG. 8 depicts exemplary display of suggestions on a single search client, in accordance with the principles of the present invention.

In particular, suggestions 800 are displayed on the single search client 550 as a search query 810 is input, character by character, in to the single search box 110. As a user begins to enter text 810 in to the single search box 110, search suggestions 800 begin to appear below the single search box 110. For instance, single search client A 550a in FIG. 8 displays search suggestions, ‘Tan at the Islands’, ‘Tanner St Aliso Viejo, CA’, ‘Tango Tapas’, and ‘Cafë Tu Tu Tango’ 800a, in response to input text (i.e. text input in the single search box 110), ‘tan’ 810a.

Single search client B 550b in FIG. 8, portrays exemplary display of search suggestions 800b with a keyboard 310. A keyboard 310 is displayed on the single search client 550b when focus is placed inside the single search box 110. A suggestion list 800b is scrollable when more search suggestions are available than can be presented in the area above the keyboard 310. Initiation of scrolling serves to hide the keyboard 310, and the keyboard 310 is restored when a user places focus back inside the single search box 110.

Single search client C 550c in FIG. 8 portrays exemplary display of search suggestions 800c without a keyboard 310.

In accordance with the principles of the present invention, the search servlet 510 returns suggested complete terms to the single search client 550 in response to a partial query term 810 typed in to the single search box 110. Suggested complete terms are retrieved by the search servlet 510 and are relevant to a current location of a requesting client/user device. Up to 10 search suggestions are displayed on the single search client 550 at a time.

If a data connection is unavailable when attempting to generate search suggestions, client-side suggestions are displayed on the single search client 550 and server-side suggestions are not.

In another potential use case, no text is entered in to the single search box 110 and a category (e.g. ‘Restaurants & Bars’, ‘Lodging’, ‘Shopping’, etc.) is selected from a category list 410 displayed on the find a place screen 400. In response to the category selection, the single search client 550 sends a proxpoi query 606 to the single search server 500. The proxpoi servlet 520 on the single search server 500 receives the proxpoi query 606 and returns search results (i.e. items stored under the selected category) for the selected category to the single search client 550, whereupon search results are subsequently displayed.

In another potential use case, some text is entered in to the single search box 110 and a category is selected from a category list 410 displayed on the find a place screen 400. In response to the category selection, the single search client 550 sends a search query (comprising a reference to the selected category and text entered in to the single search box 110) to the single search server 500. The search servlet 510 on the single search server 500 receives the search query, and returns matching search results from any category (e.g. ‘Restaurants & Bars’, ‘Lodging’, ‘Shopping’, etc.) to the single search client 550, whereupon results are subsequently displayed.

In another potential use case, a recent searches item is selected from a list of recent searches displayed under the single search box 110. In accordance with the principles of the present invention, selection of a recent searches item prompts a detail screen containing data previously retrieved for that recent searches item to be displayed on the single search client 550.

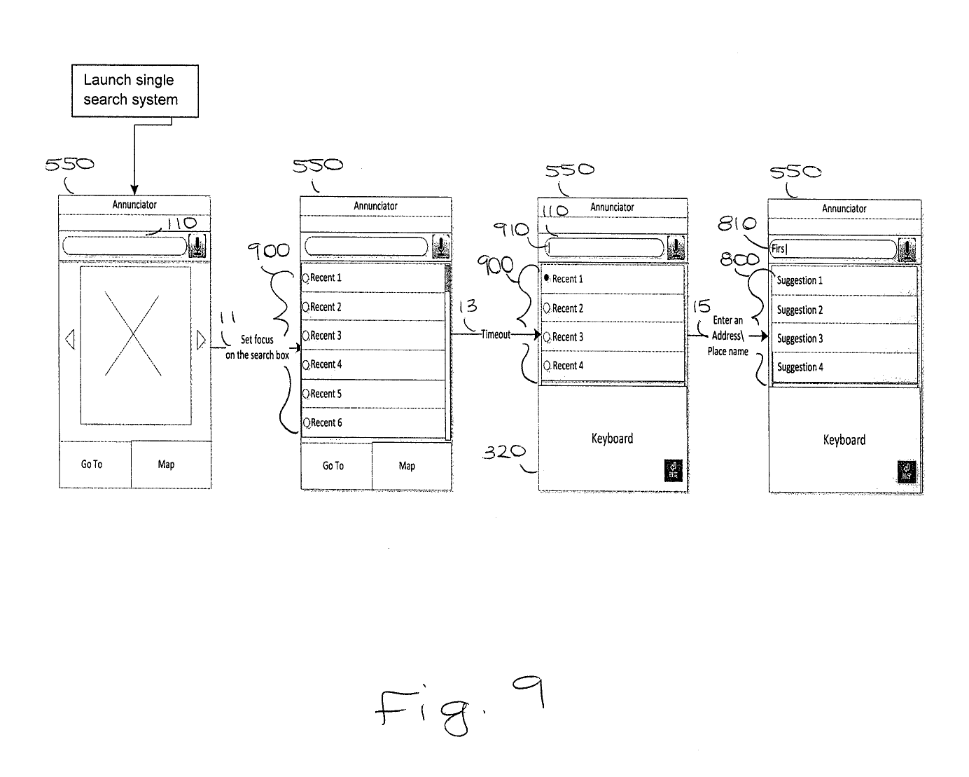

FIG. 9 portrays exemplary display of recent searches on a single search client, in accordance with the principles of the present invention.

In accordance with the principles of the present invention, a user's top 10 (configurable) recent searches 900 are displayed on the single search client 550 when focus is placed inside the single search box 110 (step 11). Recent searches 900 are ordered chronologically, with a most recently used item positioned at the top of the list. As depicted in step 13, if a predetermined timeout period lapses and focus is still inside the single search box 110, then a keyboard 310 is displayed on the single search client 550 and a cursor 910 is placed inside the single search box 110. As shown in step 15, when a user enters input text 810 in to the single search box 110, the list of recent searches 900 is replaced with a list of search suggestions 800.

In another potential use case, a suggestion is selected from a list of suggestions 800 displayed under the single search box 110. In accordance with the principles of the present invention, selection of a suggestion initiates a search for that suggestion item.

When search is initiated via selection of a suggestion item, the single search client 550 sends a search query (comprising a search-filter stored in that selected suggestion item) to the single search server 500 to request relevant data. The search servlet 510 on the single search server 500 receives the search query and returns data stored for the selected suggestion item to the single search client 550, whereupon data is displayed on a detail screen.

In yet another potential use case, a category is selected from a slide-out ‘map tray’ on the map screen 200 on the single search client 550. In response to the category selection, the single search client 550 sends a search query (comprising a reference to the selected category) to the single search server 500 to request relevant search results. The search servlet 510 on the single search server 500 receives the search query and returns relevant search results to the single search client 550, whereupon results are subsequently displayed.

In yet another potential use case, a single search is initiated via verbal instruction. In accordance with the principles of the present invention, the single search system preferably uses native Google automatic speech recognition (ASR) on the Android platform to provide automatic speech recognition (ASR) functionality. A single search via verbal instruction is initiated via selection of the ASR button (i.e. the microphone button) 140 on the single search client 550. Recognized text from an automatic speech recognition (ASR) engine is input in to the single search box 110 and sent to the search servlet 510 as a single search query. No search suggestions are provided for text that is input in to the single search box 110 via automatic speech recognition (ASR), unless such text is edited in the single search box field 110 thereafter.

Single search via automatic speech recognition (ASR) is supported for any data corpus supported within the present invention. However, on-device data (i.e. favorites, contacts, and recent searches) is not searchable via automatic speech recognition (ASR). Search results are identical for identical search queries, irrespective of whether a search query is entered via text or voice.

The single search client 550 transmits a search query and receives a search response for any use case originating from the single search box 110, any category-only search initiated via selection of a category from a category list 410, and any search initiated via selection of a suggestion item. In essence, the present invention is an intermediate step towards replacement of the existing proxpoi query 606.

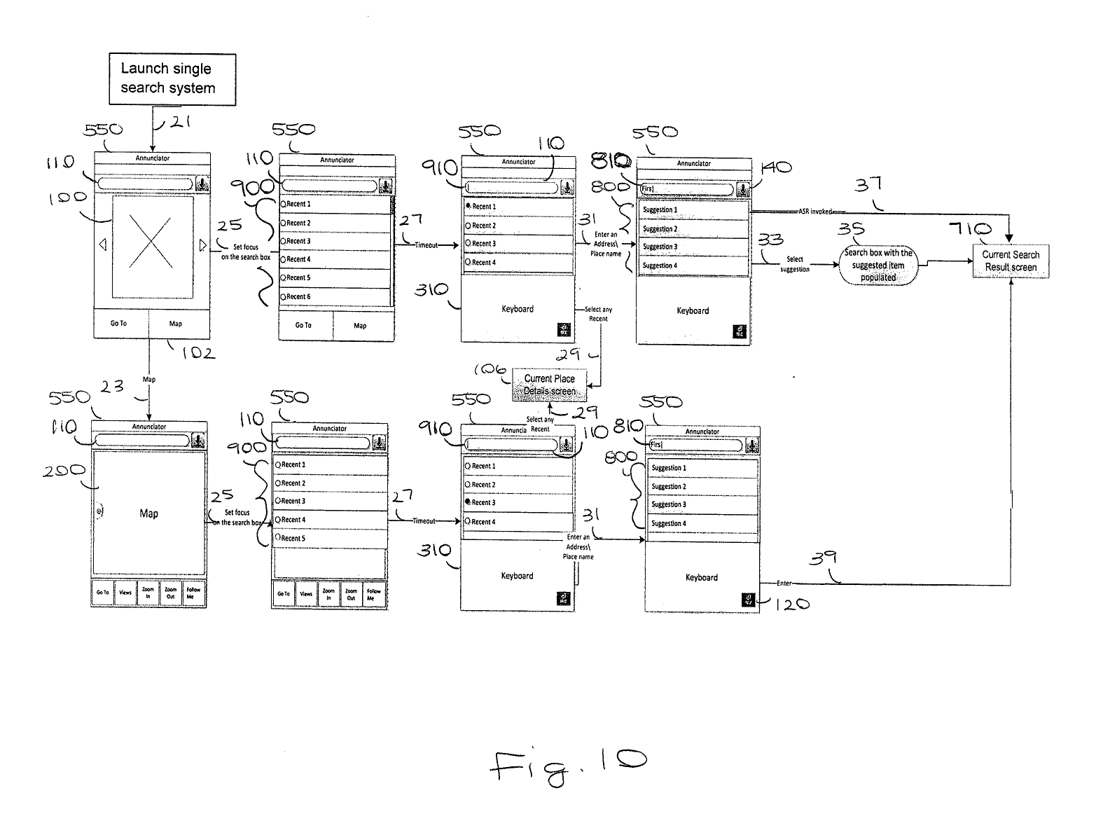

FIG. 10 depicts a user interface flow that demonstrates an exemplary single search behavior, in accordance with the principles of the present invention.

As depicted in step 21 of FIG. 10, a main application screen (in carousel view) 100 is displayed on the single search client 550 when the single search application is initially launched. As portrayed in step 23, a map screen 200 is displayed on the single search client 550 via selection of a ‘Map’ button 102 on the main application screen 100. Both the map screen 200 and the main application screen 100 on the single search client 550 contain a single search box 110.

As portrayed in step 25 of FIG. 10, setting focus inside the single search box 110 causes a list of recent searches (i.e. searches previously initiated on the single search client) 900 to be displayed under the single search box 110. As portrayed in step 27 of FIG. 10, setting focus inside the single search box 110 also initiates a timeout parameter. If a predetermined timeout period lapses, and focus is still set inside the single search box 110, then a cursor 910 is placed inside the single search box 110 and a keyboard 310 (to enable a user to enter text) is displayed on the single search client 550.

As shown in step 29 of FIG. 10, selection of a recent searches item causes a detail screen 106 containing data for that selected item to be presented on the single search client 550.

Moreover, as shown in step 31, text input 810 in the single search box 110, prompts a list of search suggestions 800 (generated for input text 810) to be displayed on the single search client 550, in lieu of recent searches 900. As depicted in step 33, selection of a suggestion item causes the selected suggestion to populate the single search box 110 (step 35) and a single search for the selected suggestion to immediately ensue. Search results for a single search initiated on the suggestion item are displayed on a results screen 710 on the single search client 550.

As shown in step 37 of FIG. 10, selection of the automatic speech recognition (ASR) button 900 on the single search client 550, prompts the single search system to retrieve a verbal search query and initiate a single search on that verbal search query. Search results for the verbal search query are displayed on a results screen 710 on the single search client 550.

As shown in step 39, selection of the search button 120 on the single search client 550 initiates a single search on a user search query input in to the single search box 110. Search results for the user search query are displayed on a results screen 710 on the single search client 550.

In accordance with the principles of the present invention, a proxpoi query 606 is used to carry out all use cases, except for cases that include searches initiated from the single search box 110, category-only searches, and search suggestions. For instance, a proxpoi query 606 is used to carry out all along-my-route searches (originated from the find a place screen 400 or the map screen 200), all carousal queries, and all explicit movie, event, gas price, and/or weather queries.

The servlet target for a proxpoi query 606 remains the same (the proxpoi servlet 520) for conventional clients 600. The servlet target for a single search query is the search servlet 510 for all clients (600 and 550).

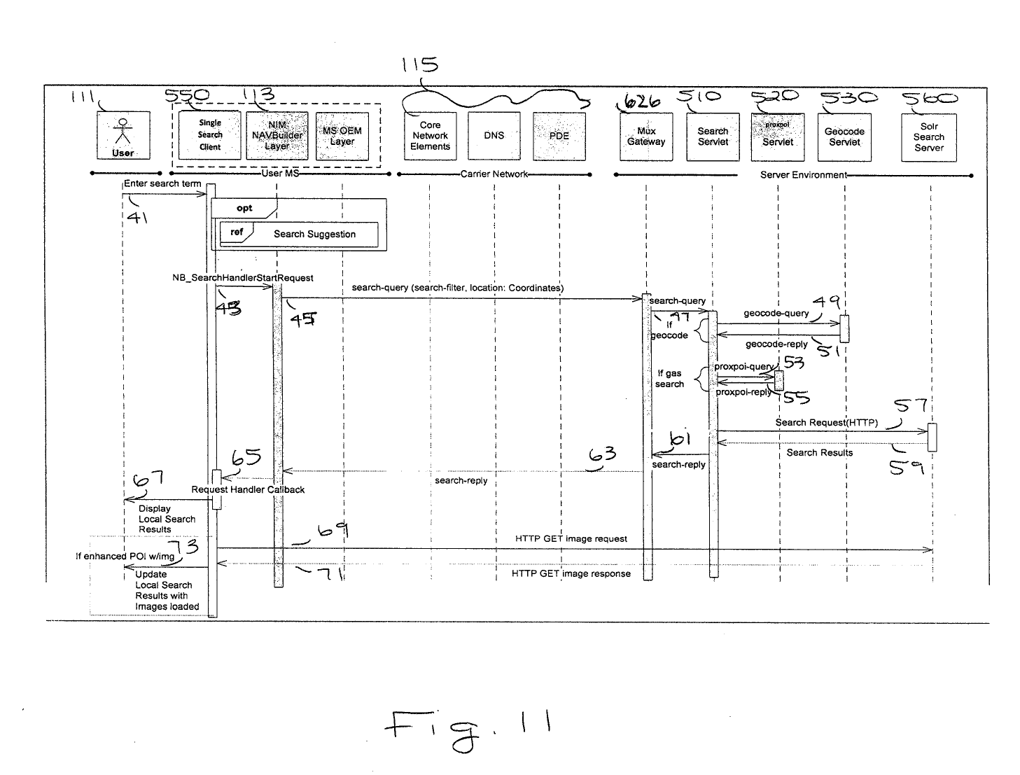

FIG. 11 shows an exemplary call flow demonstrating a search query and a search reply for a local search, in accordance with the principles of the present invention.

In particular, as depicted in step 41, a user 111 initiates a single search on the single search client 550 via a use case (e.g. via selection of the search button 120, via selection of a category, etc.) previously described herein. In response to the initiated single search, the single search client 550 initiates a search handler by, e.g., sending an NB_SearchHandlerStartRequest to a NIM NAVBuilder Layer 113, as shown in step 43. Once the search handler is initiated, a search query containing elements (e.g. an appropriate search-filter, location coordinates, etc.) relevant to the initiated single search is transmitted over the carrier network 115 to the single search server 500 (step 45). As depicted in step 47, a multiplexer 117 on the single search server 500 forwards the search query to the search servlet 510. If the search query is a conventional geocode query 602, then the search servlet 510 transmits an inter-servlet geocode query 604 to the geocode servlet 530 for appropriate geocode results, as shown in steps 49 and 51. Rather, if the search query is a conventional gas price query 606, the search servlet 510 transmits an inter-servlet proxpoi query 608 to the proxpoi servlet 520 for appropriate gas price results, as depicted in steps 53 and 55. Otherwise, the search servlet 510 sends an HTTP single search request to the Apache Solr™ search server 560 for relevant single search results (steps 57 and 59). As depicted in steps 61 and 63, a search response containing relevant search results is transmitted from the search servlet 510 back to the NIM NAVBuilder Layer 113. From the NIM NAVBuilder Layer 113, the search response is sent to the single search client 550 in a callback (e.g. a Request Handler Callback), as depicted in step 65.

If search results do not contain POIs enhanced with images, search results are displayed on the single search client 550, as shown in step 67.

Alternatively, if search results do contain POIs enhanced with images, the single search client 550 sends an HTTP GET image request to an image web server requesting images, as shown in step 69. In step 71, the Apache Solr™ search server 560 returns an HTTP GET image response containing images to the single search client 550. Local search results are updated with loaded images and displayed on the single search client 550, as portrayed in step 67.

In accordance with the principles of the present invention, the single search system considers the following data corpuses for purposes of single search: points of interest (POI) (including landmarks), POI categories, addresses (street names, cities, states, zip codes), gas stations, favorites, contacts, recent searches, airports, movies, and events.

A user may enter a search query in to the single search box 110 to convey a search intent that spans one or more data corpuses listed above. In accordance with the principles of the present invention, meta-data concerning a nature of a search is not provided to the single search server 500, thus the search servlet 510 must search against all available data corpuses to find relevant search results.

The following source parts of each of the data corpuses listed above are considered for purposes of single search: name, category (for points of interest); street number, street address, city, state, zip, country (for addresses); gas station name (for gas stations); favorite name, street number, street address, city, state, zip, country (for favorites); contact name, street number, street address, city, state, zip, country of ALL (home, work etc.) contact addresses (for contacts); recent searches (for recent searches); airport name, airport code, airport city (for airports); movie name, genre (for movies); and event name, event type (for events).

To determine suggestion candidates, input text 810 (i.e. text input in the single search box 110) is compared to every word of every data source part. If input text 810 matches the start of any word of any available data source item, then that data source item is considered a match and displayed on the single search client 550 as a suggestion. Suggestion candidates are continuously determined and refined as additional characters are entered in to the single search box 110. Stop words are not considered for purposes of determining a suggestion candidate. For instance, ‘Chilis Bar and Grill’ is not a suggested item in response to input text 810, ‘an’.

When input text 810 maps directly to a POI category name (or a predefined category alias), the single search server 500 returns a single category suggestion to the single search client 550 and additionally returns suggestions based on the original search query.

For example, when input text 810 ‘food’ is entered in the single search box 110, the single search server 500 detects that ‘food’ is an alias for POI category, ‘Restaurants and Bars’. Hence, the single search server 500 returns a suggestion for POI category, ‘Restaurants and Bars’, to the single search client 550, and additionally searches for other suggestions matching search term, ‘food’. In this case, the category suggestion is the first result returned to the single search client 550. Additional suggestions are returned in order of total relevance.

In determining POI, address, or airport suggestion candidates, a limited search boundary is not enforced.

In accordance with the principles of the present invention, different types of suggestions contain different item attributes. For instance, a suggestion for a POI item contains a POI name and an address. For example, ‘Chillis Bar and Grill, 26632 Aliso Creek Rd, Aliso Viejo, CA’ is a valid POI suggestion in response to input text 810, ‘ch’.

A suggestion for a POI category contains a POI category name. For example, “Chinese Restaurants’ is a valid POI category suggestion in response to input text 810, ‘ch’.

A suggestion for a street name contains a street name, city, and state. For example, ‘Chabot Road, Laguna Niguel, CA’ is a valid street name suggestion in response to input text 810, ‘ch’.

A suggestion for a city name contains a city and state. For example, ‘Chicago, Ill.’ is a valid city name suggestion in response to input text 810, ‘ch’.

A suggestion for a state name contains a state. For example, ‘North Carolina’ is a valid state name suggestion in response to input text 810, ‘ca’.

A suggestion for a zip code contains a city, state, and zip code. For example, ‘Boston, CA, 02115’ is a valid zip code suggestion in response to input text 810, ‘02115’.

A suggestion for a contact name contains a contact name and address. For example, ‘Charles De Gaulle, 100 Pennsylvania Ave, Washington, D.C.’ is a valid contact name suggestion in response to input text 810, ‘ch’.

A suggestion for a favorite name contains a favorite name and address. For example, ‘Hard Rock Café, Las Vegas, CA’ is a valid favorite name suggestion in response to input text 810, ‘ca’.

A suggestion for an airport contains an airport name, city, and state. For example, ‘Boston Logan International Airport, Boston, Mass.’ is a valid airport suggestion in response to input text 810, ‘Io’.

Suggestion candidates that are geographically closer to a requesting client/user device are considered more relevant than suggestion candidates that are further away. The present invention uses a fast but approximate distance calculation to compute geographic proximity (as opposed to a more precise but slower algorithm).

In accordance with the principles of the present invention, suggestions are grouped in to two buckets, one bucket comprising server-generated items and the other bucket comprising client-generated items. Up to ten relevant suggestions may be presented on the single search client 550 at a time. Of those ten relevant suggestions, two suggestions are reserved for client-generated suggestions (when client-generated suggestions are available) and 8 suggestions are reserved for server-generated suggestions. However, if fewer than eight server-generated suggestions are available, and more than two client-generated suggestions are available, then unfilled server slots are used for client-generated suggestions. The single search client 550 is engineered so that it may easily be switched to display client-generated suggestions first and server-generated suggestions second, if later deemed necessary.

Server-generated suggestions are ordered by relevance, with a most relevant item (usually the item that is geographically closest to the requesting client/user device or a center of search) positioned at the top of the list. Relevance ordering applies to search results, as well. For instance, when a user selects the search button, search results are presented on the single search client 550 in order of relevance. Client-generated suggestions are ordered alphabetically.

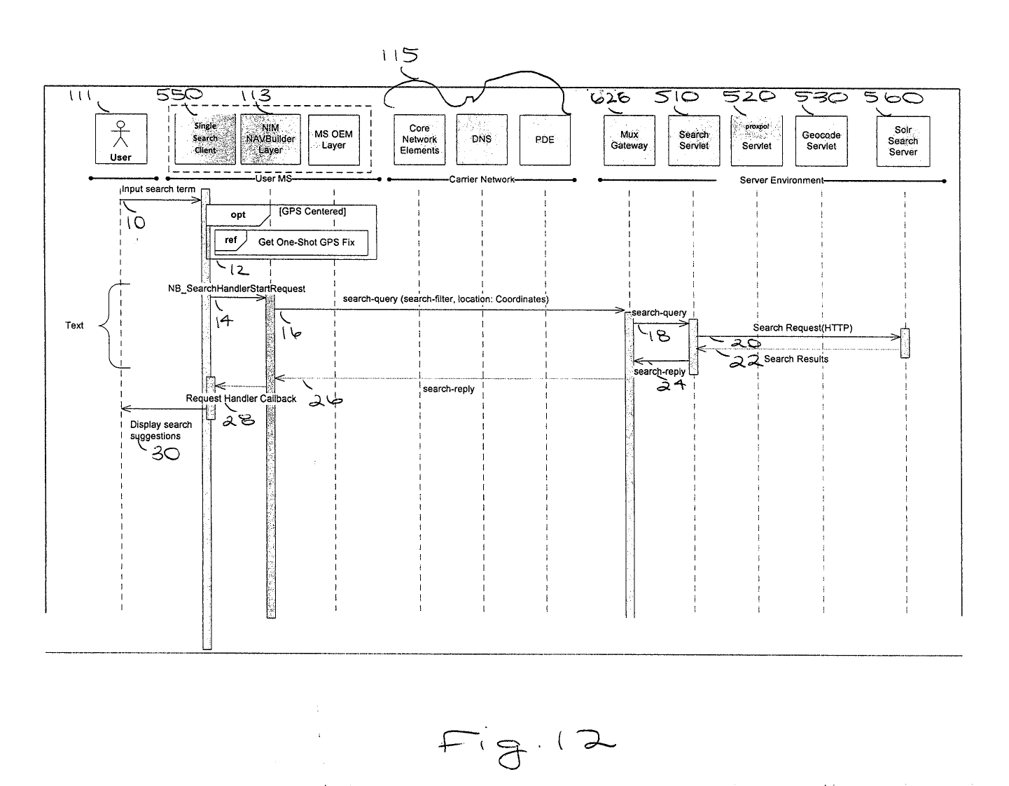

FIG. 12 depicts an exemplary call flow demonstrating a search query and a search reply for suggestions, in accordance with the principles of the present invention.

In particular, as depicted in step 10 of FIG. 12, text is input in to the single search box 110 on the single search client 550. Once focus is placed inside the single search box 110, a coarse location fix is retrieved for a requesting client/user device (step 12). If a last known fine fix for the requesting client/user device is less than 2 minutes old, then that last know fine fix is used to generate suggestions/search results. Otherwise, the coarse location fix is used. For iOS, course fix with a 10000 m accuracy filter is preferably used.

As depicted in step 14, the single search client 550 initiates a search handler in response to input text 810, by, e.g., sending an NB_SearchHandlerStartRequest to a NIM NAVBuilder Layer 113. Once the search handler is initiated, a search query for suggestions (i.e. a search query with a ‘suggest’ search-filter and current location coordinates) is transmitted over the carrier network 115 to the single search server 500, as shown in step 16. As depicted in step 18, a multiplexer 117 on the single search server 500 forwards the search query to the search servlet 510. The search servlet 510 receives the search query (i.e. suggest query) and sends an HTTP single search request to the Apache Solr™ search server 560 for relevant suggestion results, as shown in steps 20 and 22. In steps 24 and 26, a search response containing relevant suggestion results is transmitted from the search servlet 510 back to the NIM NAVBuilder Layer 113. From the NIM NAVBuilder Layer 113, the search response is sent to the single search client 550 in a callback (e.g. a Request Handler Callback) and suggestions are subsequently displayed thereon (steps 28 and 30).

Each character entered in to the single search box 110 invokes the call flow depicted in FIG. 12. Suggestions returned to the single search client 550 may be of any searchable data type stored in the single search system.

If suggestion generation is expected to take more than 1 second to complete, a spinning activity indicator is displayed inside the single search box 110. This spinning activity indicator is stopped when search results are found, or when an error is returned from the single search server 500. User input is not blocked by suggestion generation.

A long press on a search suggestion is used as a mechanism to edit that selected suggestion. When a long press is implemented on a search suggestion, a suggestion string stored in that selected suggestion populates the single search box 110. The suggestion string in the single search box 110 may then be edited and the search button 120 (e.g. magnifying glass button, ‘enter’ key, etc.) may be manually selected to initiate a search.

A tap on a search suggestion (as opposed to a long press) automatically initiates a search on that suggestion item.

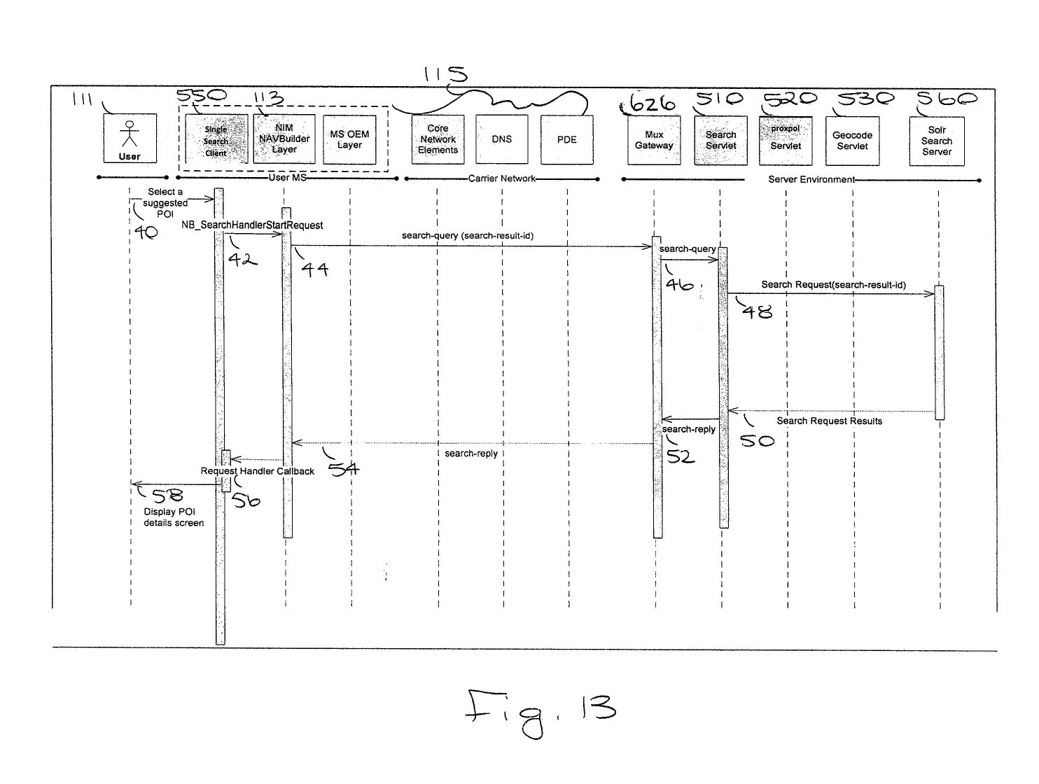

FIG. 13 portrays an exemplary call flow demonstrating a search query and a search reply for a selected POI suggestion, in accordance with the principles of the present invention.

As depicted in step 40 of FIG. 13, a user selects a POI suggestion displayed under the single search box 110 on the single search client 550. In response to the suggestion selection, the single search client 550 initiates a search handler by, e.g., sending an NB_SearchHandlerStartRequest to a NIM NAVBuilder Layer 113, as shown in step 42. Once the search handler is initiated, a search query, containing a search-result-id retrieved from the suggestion item, is transmitted over the carrier network 115 to the single search server 500, as depicted in step 44. In step 46, a multiplexer 117 on the single search server 500 forwards the search query to the search servlet 510. As depicted in steps 48 and 50, the search servlet 510 receives the search query and sends a search request (containing a search-result-id retrieved from the suggestion item) to the Apache Solr™ search server 560 for relevant search results. A search response containing relevant search results is then transmitted from the search servlet 510 back to the NIM NAVBuilder Layer 113, as shown in steps 52 and 54. From the NIM NAVBuilder Layer 113, the search response is sent to the single search client 550 in a callback (e.g. a Request Handler Callback) (step 56) and a POI detail screen containing data for the selected POI item is subsequently displayed thereon (step 58).

If upon selection of a suggestion item, it is known that the suggestion item will yield exactly one search result upon search, then a results set is bypassed on the single search client 550 and an item detail screen for the selected suggestion is displayed instead. For example, upon selecting a suggested contact, a contact detail screen for that selected contact is presented on the single search client 550. Moreover, upon selecting a suggested POI item (a suggested POI item that includes a POI address), a POI detail screen for that selected POI is presented on the single search client 550. Further, upon selecting a suggested address, an address detail screen for that selected address is presented on the single search client 550.

If a user does not select an item from a list of suggestion items or if search suggestions are unavailable to a user, then pressure on the search button 120 (i.e. an ‘enter’ key) initiates search.

Being that a single search box 110 is able to support a variety of input styles, it is often difficult to know for certain what type of search results a user intends to acquire. The manner in which a search query is handled depends greatly upon whether that search query is intended for an address search or for a POI search. In accordance with the principles of the present invention, the single search client passes a search query through a context filtering sequence to decipher user intent.

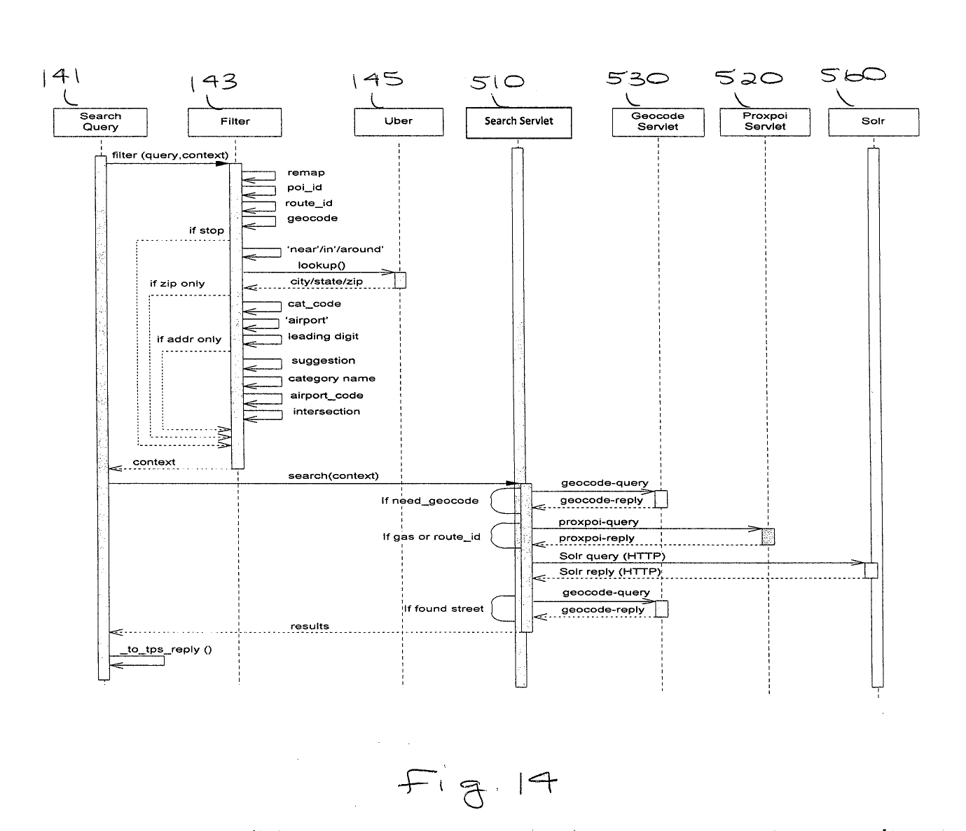

FIG. 14 depicts an exemplary context filtering sequence, in accordance with the principles of the present invention.

As depicted in FIG. 14, each search query 141 entered in the single search box 110 is converted from TPS protocol elements/attributes to a searchQuery object, and then passed into a contextFilter 143 for processing.

In accordance with the principles of the present invention, the single search system applies several assumptions when performing address-specific filtering. In particular, when filtering a search query for address data, the present invention assumes that a term beginning with a digit is likely a street number (i.e. matching result items containing a street number are awarded a higher relevance score). In addition, a search query containing 5 characters that are all digits is assumed to be a zip code when no other terms are embedded in that search query. Likewise, a search query containing 5 characters that are all digits is assumed to be a potential zip code when other terms are embedded in that search query. Terms ‘in’, ‘near’, and ‘around’ accompanied by pre- and post-terms within a search query, indicate that some portion of an address may follow. Also, the term ‘in’ in a search query for address data likely represents a state abbreviation or an address separator. In accordance with the principles of the present invention, a query term that matches a city name that exists in more than one state is not considered a location reference when no additional location references are embedded in that search query.

When a number is the only piece of data entered in to the single search box 110, the single search system treats that number as a potential zip code entry (i.e. zip code results are awarded a higher relevance score), as opposed to a potential street number. Additionally, when a potential city name is the only piece of data entered in to the single search box 110, the single search server 500 treats that city name as a POI query. For example, ‘Washington’ is a potential city name. However, ‘Washington’ is also a potential state name and a common surname. Therefore, the term, ‘Washington’, alone, is too ambiguous to use as a location reference. When both city name and state name (or state abbreviation) make up a complete search term, a geocoded city center for that city and state (e.g. Aliso Viejo, CA) is returned by the single search server 500.

When a street name is input in to the single search box 110 without a street number, the single search server 500 does not return an address range in reply. Instead, the single search server 500 returns a street name, a city, a state, and a center-point of the combined street segments. For example, search query, ‘timbo street Irvine, ca’, corresponds to several stored data entries, e.g., [1-4] Timbo Street, Irvine CA; [5-7] Timbo Street, Irvine CA; [8-9] Timbo Street, Irvine CA; etc. Each relevant data entry represents a different part of a street and contains a different start and end point (based on number ranges). A valid suggestion for search query, ‘timbo street Irvine, ca’, is ‘Timbo St. Irvine CA’, in accordance with the principles of the present invention.

Moreover, the single search system drops alpha characters that are embedded in a street number in a search query, unless a map database contains information necessary to validate alpha characters. For example, if search query, ‘6A Liberty Aliso Viejo, CA’, is entered in to the single search box 110, search (via geocode) returns address ‘6 Liberty Aliso Viejo, CA’.

When filtering a search query for city, state, and postal code, an ‘uber’ (location match) model 145 is used.

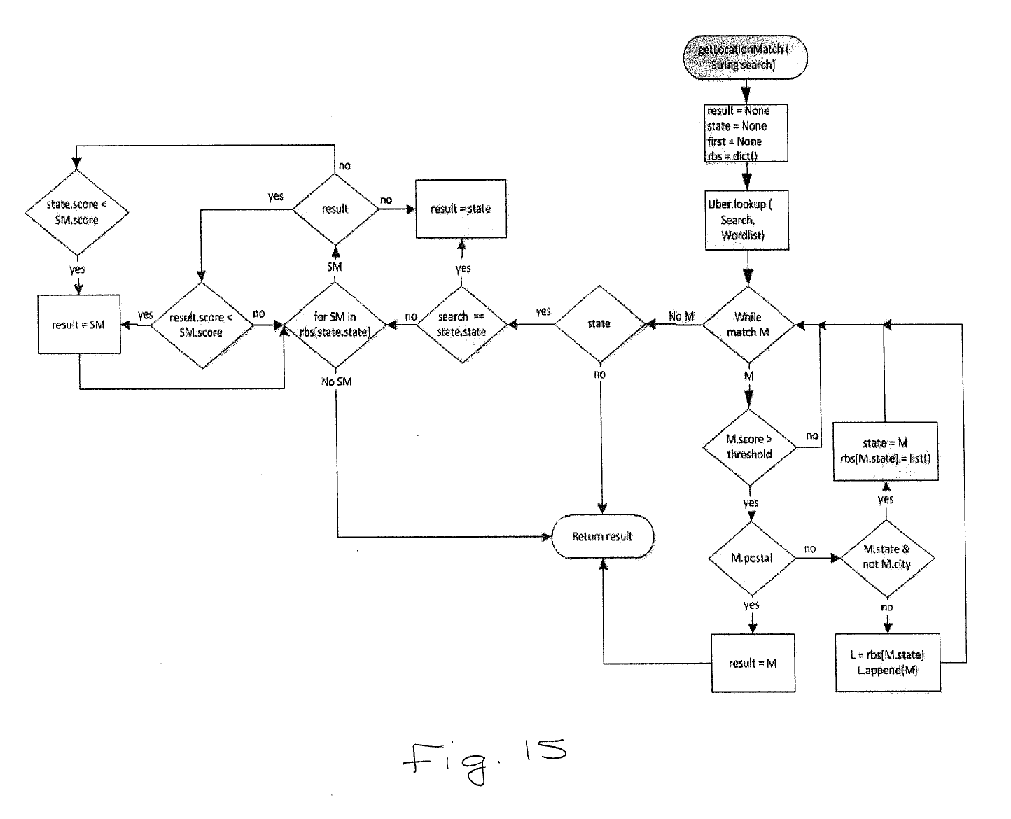

FIG. 15 depicts an exemplary logic flow for accepting uber results, in accordance with the principles of the present invention.

In particular, an uber (location match) model 145 is used to search spatial indices for full or partial matches to search terms. Uber results comprise a score, a latitude, and a longitude for each record. Uber results always contain one of the following data sets: (city, state, postal code), (city, state), or (state).

The search index in the single search system contains different types of data from several different vendors. Consequently, the present invention requires a method of query specialization to provide hinting wherever possible. For instance, specialization for the inventive suggestion functionality comprises a determination of whether or not a token in input text 810 (i.e. text input to the single search box 110) contains a leading digit. When input text 810 (i.e. text input to the single search box 110) contains a leading digit, a suggestion query is sent to the single search server 500 to examine specific street ranges in stored data, and other primary_text matches. Suggestions are provided in real time. Therefore, a user may easily add specificity to a search before selecting a result.

For general searches (e.g. searches initiated by pressing the search button), logic is a bit different and geocode is used freely as needed.

In accordance with the principles of the present invention, category filters available for searching a POI include: a category filter for searching by name and a category filter for searching by category code. The single search system uses an existing V5 category search code (used in searchbuilder 540) to identify POI category name matches in a search query.

In particular, each category name is mapped to a server ‘X’ code on the single search server 500. When a category code is sent from the single search client 550 to the single search server 500, the single search server 500 maps the category code received from the single search client 550 (in client ‘A’ code) to server ‘X’ code, in accordance with a scheme specified by the single search client 550. Once server ‘X’ code is obtained, the single search server 500 sends the category code to the Apache Solr™ search engine 560 to retrieve a requested number of matching POI records.

In accordance with the principles of the present invention, the single search system filters gas price search queries by keyword (e.g. ‘fuel’) or by brand name (e.g. ‘chevron’). Keywords and brand names are detected in a category_keyword filter. Special handling exists to proxy a search query to the proxpoi servlet 520 for access to gas feed data.

In accordance with the principles of the present invention, the single search system supports several types of single search.

In particular, address search is supported by the single search system. In accordance with the principles of the present invention, a search query to initiate a search for an address contains a full address (i.e. street number, street name, city, state, and zip), a partial address (i.e. any one or more address parts), and/or an intersection.

Intersections are embedded in a search query in either of the following formats:

1. street name 1 & street name 2

2. street name 1 and street name 2

City, state, and zip are optional items in an intersection search query. For example, ‘Aliso Creek and Alicia Parkway’ is a valid intersection search query, as is, ‘Sand Canyon & Alton, Irvine, CA’.

The single search system also supports search for a POI about a specific location. In accordance with the principles of the present invention, a search query to initiate a search for a POI about a specific location contains a location reference.

The single search system supports the following location references: address references (e.g. ‘Walmart Laguna Niguel’) landmark references (e.g. ‘Starbucks Yankees Stadium’), airport references (e.g. ‘Starbucks JFK’), and contact's address references (e.g. ‘Macy's near John’, where ‘John’ is a contact).

An address reference contains one or more of the following components (in any combination): city, state, and/or postal code. For example, ‘Borders in Aliso Viejo, CA’ and ‘McDonalds 92656’ are both examples of search queries with valid address references. When a city and state name are embedded in a user search query with other search terms (with or without separator keywords), the single search server 500 centers search on the geocoded city center of the city and state name and performs a search operation on the other search terms.

An airport reference contains an airport name and/or an airport code. A contact's address reference may contain a partial contact name. If a contact's address reference yields multiple matching contact names, and/or if multiple addresses are stored for a matching contact name, then the single search system prompts a user to select an option from a set of potential options.

A search operation excludes words in a search query that identify a location reference. For example, search query ‘walmart near Irvine CA’, prompts the single search server 500 to identify location reference, ‘Irvine, CA’, and search ‘walmart’. The word ‘near’ is dropped from both the geocode and the search query.

A location reference in a search query may be positioned before or after a POI name. For example, ‘sofitel hotel san carlos ca’ and ‘San carlos ca sofitol hotel’ are both valid search queries. Location references are preferably limited to city, state, zip, or any combination thereof. For example, search queries, ‘sofitel san carlos, CA’, ‘sofitel san carlos’, and ‘sofitel 92656’ all contain valid location references. The single search system does not support street names or street numbers in a location reference.

The present invention tolerates location references with minor spelling errors (e.g. ‘sofitel hotel san carrlos ca’). However, support for spelling errors is limited. Approximately only 2 character misspellings are supported for a location reference (a function of the misspelling algorithm).

In accordance with the principles of the present invention, the single search system also supports search for a POI without a location reference. A search query to initiate a search for a POI, without a location reference, includes a full POI name (e.g. ‘in-n-out burger’), a partial POI name (e.g. ‘Bellagio’ for ‘Bellagio Hotel and Casino’), a POI name with a minor misspelling (e.g. ‘Bellagio’ for ‘Belagio Hotel and Casino’), a POI name with words in an incorrect order (compared to the actual POI name) (e.g. ‘studios universal’ for ‘universal studios hollywood’), and/or a POI category (e.g. ‘Department Stores’).

When no location reference is embedded in a search query, the single search system defaults to searching about a current location of a requesting client/user device. If a current location is unavailable, the single search system searches about a last known location of a requesting client/user device.

The single search system also supports search for a POI belonging to a specific category. In accordance with the principles of the present invention, a search query to initiate a search for a POI belonging to a specific category contains a category name. Primary category names (e.g. ‘Pharmacies’) and secondary category names (synonyms) (e.g. ‘Sporting Goods, Decatur, Ill.’) are both supported within the present invention. For example, ‘Chinese Restaurants’ is an exemplary primary category name and ‘Chinese Food’ is an exemplary synonym for that primary category name. Query reformulation requirements apply to POI category queries. Matching is tolerant to limited user input error.

In accordance with the principles of the present invention, both a POI name and a POI category may be embedded in a user search query. For example, ‘Avis Car Rental’ is an exemplary search query with POI and category intent (‘Avis’ is the POI name and ‘Car Rental’ is the category name).

The single search system additionally supports contacts search, favorites search, and recent searches search. However, contacts search, favorites search, and recent searches search all operate solely on the client side. Therefore, any contacts, favorites, and/or recent searches matching supplied search criteria are presented on the single search client 550 as search suggestions only.

The single search system also preferably supports POI search for verizon wireless stores. In accordance with the principles of the present invention, a search query to initiate a search for a Verizon wireless store contains any one or more of the following search terms: ‘Verizon Wireless’, ‘Verizon Wireless Stores’, ‘Verizon Wireless Store’, ‘VZW’, ‘VZW Stores’, ‘VZW Store’, ‘Verizon’, ‘Veirzon’, ‘Veriozn’, ‘Verizon Stores’, and ‘Verizon Store’. This list of ‘Verizon’ search terms is configurable on the single search server 500 and all query reformulation rules apply.

In accordance with the principles of the present invention, the single search system also supports road side assistance search. In particular, a search query to initiate a search for road side assistance contains one or more of the following search terms: ‘road side assistance’ and ‘help’.

The single search system also supports navigation search. In accordance with the principles of the present invention, a search query to initiate a search for navigation data contains an instruction term. The single search system treats certain instruction terms embedded in a user search query as requests to begin navigation to a particular destination. For instance, the single search system treats the following search terms as special instruction terms: ‘Go’, ‘Goto’, ‘Go to’, and ‘Navigate’. To prompt navigation, instruction terms must be the first word(s) in a search query.

Search terms following an instruction term (e.g. ‘Go’, ‘Goto’, ‘Go to’, and ‘Navigate’) must represent a destination. An instruction term prompts a search for navigation data when a destination term following that instruction term can be uniquely identified (i.e. when there is only one unambiguous result available for a destination term). A destination term may be a term stored in any of the following data corpuses: favorites (e.g. ‘Go Home’), contacts (e.g. ‘Go to John’), POIs (e.g. ‘Goto Staples Center’), addresses (e.g. ‘Go 2185 El Camino Real, Santa Clara, CA), and landmarks (e.g. ‘Goto Space Needle).

Search suggestions are not generated for special instruction words. For example, search suggestions are generated for a letter ‘G’ typed in to the single search box 110, but are not generated for the word ‘Go’ typed in to the single search box 110.

In accordance with the principles of the present invention, the single search system additionally supports airport search. A search query to initiate a search for an airport contains an airport name, an airport code, and/or an airport city (e.g. ‘Newark Airport’). The word ‘airport’ must be embedded in a search query to initiate an airport search.

The single search system also supports gas station/gas price search. In accordance with the principles of the present invention, a search query to initiate a search for a gas station/gas price item contains a gas station/gas price keyword. For example, keyword ‘GAS’ triggers a search for a gas POI when entered in to the single search box 110. The present invention treats a search query comprising any one or more of the following search terms as a gas station/gas price search query: gas, gasoline, petrol, fuel, chevron, arco, BP, exxon, valero, texaco, 76, conoco, rotten robbie, and AM PM and AM/PM. This list of keywords is configurable on the single search server 500 and all query reformulation rules apply.

A user may use separator words and punctuation marks in a search query to demarcate a POI reference sub-string from a location reference sub-string. The following separator words and punctuation marks are supported within the present invention: ‘in’, ‘near’, ‘at’, ‘around’, ‘,’, ‘;’, and ‘:’. For example, ‘Walmart in Laguna Niguel’ is a valid search query containing a separator word.

For purposes of matching, the single search system ignores stop words ‘a’, ‘an’, ‘the’, and ‘by’ (e.g. Courtyard by Marriott) embedded in a user search query. Stop words, as a concept, exist so that search engines can ignore terms that are insignificant in a search query, due to commonality. A stop word is insignificant in a search query, when other words embedded in that search query provide meaningful context to a search. In accordance with the principles of the present invention, the single search client 550 transmits a suggestion query when a user inputs stop words in to the single search box 110. The list of stop words provided herein is configurable on the single search server 500 and easily adaptable.

In accordance with the principles of the present invention, the single search system is tolerant to the presence or absence of special characters in a search query. For example, search queries, ‘Jo-Ann’ and ‘Joann’ both yield search result ‘Jo-Ann Fabric & Craft Stores’ (‘&’ and ‘-’ are present in both the search queries and the POI name, respectively). Special characters are text characters that fall outside the range of [a-zA-z0-9].

The single search system additionally tolerates minor misspellings of search query terms. In particular, the single search system handles misspellings that do not cause a significant difference in a phonetic ‘sounds-like’ value of a word (e.g. ‘fone’ is close enough to ‘phone’), misspellings that consist of a transposition of two consecutive terms (e.g. ceiling and cieling or yellow and yellwo), and misspellings that consist of two closer keys (e.g. ‘mcdonalfs’ and ‘mcdonalds’, with f and d being the closer keys). For example, the single search system correctly handles the following misspellings of search term, ‘Walmart’: ‘wlmart’, ‘wallmart’, ‘walmrt’, and ‘wlmrt’.

To provide tolerance for user input errors (e.g. incorrect spelling, words out of order, etc.), the single search system attempts to normalize user search queries. For instance, search queries entered in to the single search box 110 are insensitive to case. Therefore, upper or lower case text in a search query does not matter, except when assigning a relevance score. Search queries are additionally insensitive to singular (e.g. curve) and plural form (e.g. curves), (except when assigning a relevance score), and all variant forms (suffixes mostly) of a root word, as supported by the underlying search engine (i.e. Apache Solr™) (e.g. connection’, ‘connections’, ‘connective’, ‘connected’, and ‘connecting’ all yield ‘connect’ as a stem).

In accordance with the principles of the present invention, the single search system normalizes data in to a single document format so that data may be searched from several different sources. Table 4 depicts an exemplary single document format used to build a generic search system within the present invention.

TABLE 4

| name | type | Indexed | omitNorms | Stored | MultiValued | Required |
|---|---|---|---|---|---|---|
| id | string | TRUE | TRUE | TRUE | | TRUE |
| name | textstd | TRUE | TRUE | TRUE | | |
| name_stem | text | TRUE | TRUE | | | |
| doc_type | string | TRUE | | TRUE | | |
| signature | string | TRUE | | | | |
| primary_text | text | TRUE | TRUE | TRUE | TRUE | |
| suggest_edgengrams | edgytext | TRUE | TRUE | | TRUE | |
| address_type | string | TRUE | | TRUE | | |
| airport | textCaseIgnore | TRUE | TRUE | TRUE | | |
| country | textCaseIgnore | TRUE | TRUE | TRUE | | |
| state | textCaseIgnore | TRUE | TRUE | TRUE | | |
| city | textCaseIgnore | TRUE | TRUE | TRUE | | |
| zip | textCaseIgnore | TRUE | TRUE | TRUE | | |
| street1 | textCaseIgnore | TRUE | TRUE | TRUE | | |
| street2 | textCaseIgnore | | | TRUE | | |
| streetnum | textCaseIgnore | | | TRUE | | |
| streetnum_min | tint | TRUE | | TRUE | | |
| streetnum_max | tint | TRUE | | TRUE | | |
| phone_country | string | | | TRUE | | |
| phone_area | string | | | TRUE | | |
| phone_num | string | | | TRUE | | |
| phone_ext | string | | | TRUE | | |
| phone_type | string | | | TRUE | | |
| category_code | textCaseIgnore | TRUE | TRUE | TRUE | | |
| category_list | textCaseIgnore | TRUE | TRUE | TRUE | | |
| naics_category | textCaseIgnore | | | TRUE | | |
| category_name | textAliased | TRUE | TRUE | TRUE | | |
| orig_category | string | | | TRUE | | |
| lat | tdouble | TRUE | | TRUE | | |
| Ion | tdouble | TRUE | | TRUE | | |
| latlon | location | TRUE | TRUE | TRUE | FALSE | |
| pvid | string | FALSE | | TRUE | | |
| vendor_code | textCaseIgnore | FALSE | | TRUE | | |
| average_rating | tfloat | FALSE | | TRUE | | |
| rating_count | tlong | FALSE | | TRUE | | |
| tagline | string | FALSE | | TRUE | | |
| enhanced_pairs | string | FALSE | | TRUE | TRUE | |

As depicted in Table 4, different data sources have different data fields. Fields ‘id’ and ‘cdoc_type’ are required for every data record stored in the single search system. Blank fields are inserted by an import process wherever data does not exist.

Table 5 portrays exemplary strings that are acceptable in a doc_type field.

TABLE 5

| | Primary Search | Secondary | |
|---|---|---|---|
| Value | Field(s) | Search Field(s) | Description |
| POI | name | category list, | |
| | | city, state, | |
| | | zip | |
| AIRPORT | name, airport | city | |
| | code | | |
| ADDRESS | street1, | city, zip, state | |
| | streetnum_min, | | |
| | streetnum_max | | |
| ADDRESS: ZIP | zip | city | NO LONGER |
| | | | USED |
| ADDRESS: CITY | city | State | NO LONGER |
| | | | USED |
| ADDRESS: STATE | state | | NO LONGER |
| | | | USED |
| CATEGORY | category_name | category_code | NO LONGER |
| | | | USED |
| VZW-POI | name, | city, state, zip | |
| | category_code | | |

In accordance with the principles of the present invention, to handle search requests for street names, the single search system normalizes street names embedded in a user search query with respect to the following issues: street types (suffixes), cardinal directions, and ordinal street names. Search queries are normalized against source data at query time.

At query time, the present invention uses the following exemplary constructs to normalize street abbreviations embedded in a user search query:
street-name-alias:
   st:
      street
      saint
      st.
      str
      str.
   ave:
      avenue
      ave.

For example, strings: ‘street’, ‘saint’, ‘st.’, ‘str’, and ‘str.’, embedded in a user search query are all mapped to street abbreviation ‘st’ at query time. Similarly, the present invention maps strings ‘avenue’ and ‘ave.’ embedded in a user search query to street abbreviation ‘aye’ at query time. Data normalization is provided for each street type found in Navteq RDF data.

When deemed appropriate, the single search system uses the following exemplary constructs to normalize cardinal directions embedded in a user search query:
directional-norms:
   s:
      south
   sw:
      southwest
      south west
   se:
      southeast
      south east
   n:
      north
   nw:
      northwest
      north west
   ne:
      northeast
      north east
   w:
      west
   e:
      east

Moreover, the single search system uses existing ordinal mapping functions from map data team and/or geocode parsing to normalize ordinal strings embedded in a user search query. The single search system maps from ordinal to text-only to benefit from sounds-like and phonetic algorithms. In accordance with the principles of the present invention, ordinal strings embedded in a user search query are normalized using the following exemplary constructs:
ordinal-street-norms:
   first
      1st
   second:
      2nd
   third:
      3rd . . .
   twenty:
   thirty:
etc. . . .

A search query transmitted to the single search server 500 for relevant search results comprises the following elements: position, iter-command, search-filter, directed, route-corridor, and want-premium placement. The iter-command element and the search-filter element are both required in a search query, whereas position, directed, route-corridor and want-premium-placement elements are all optional and embedded in a search query in accordance with unique circumstances of a given search request.

In accordance with the principles of the present invention, a position element is included in a search query to represent a center of a proximity search. If the single search client 550 is able to obtain a current position of a requesting client/user device or a recent position of a requesting client/user device, then a position element comprising that current/recent position is embedded in a relevant search query. Only when a location fix is unavailable, may a position element be eliminated from a search query. Moreover, when performing an along-my-route search, the position element in a search query specifies a position on that route from which to start search. If a start position is not located on a searched route, then search begins from a point on that searched route, nearest the start position.

A directed element is included in a search query to optimize search in a particular direction of travel (as specified in a location reference).

In addition, a route-corridor element is included in a search query to enable an along-my-route search. A route-corridor element (if present in a search query) indicates that only POIs along a requested route should be displayed on the map screen 200, and for safety cameras along that route.

A route-id attribute is included in a search query to initiate a more general search of POIs along a route. In particular, a route-id attribute is embedded in a search query to request POIs in response to a find a place request.

A want-premium-placement element is included in a search query to request that a search response (i.e. a results set) contain a premium placement ad. When a premium placement ad is requested in a search query, an ad is returned in a corresponding results set, in addition to search items (specified in a ‘number’ attribute in the ‘iter-command’ element) requested for that single search. For example, if 10 local search items are requested for a single search, then a premium placement ad is returned to the single search client 550 as an 11^{th} item in a results set.

An iter-command element and a search-filter element are required elements in a search query. The iter-command element holds an iteration command for a search query and the search-filter element represents filter criteria. More particularly, the search-filter element specifies which attributes to search on and what information/details are required in a results set.

In accordance with the principles of the present invention, a single search is controlled by parameters of the search-filter element. Parameters of the search-filter element include: a result-style element and anywhere from 1 to n key-value pair elements.

In accordance with the principles of the present invention, the result-style element in the search-filter element restricts the amount of information displayed in a results set. If no result-style element is included in the search-filter element, then all information/details must be displayed in a results set. More particularly, the result-style element in the search-filter element comprises a key attribute (a string). The key attribute describes which of an available set of details to return to the single search client 550 for each search result. More particularly, the key attribute in the result-style element contains one of the following possible values: ‘suggest’ (i.e. a key attribute value used when sending a suggestion request to the single search server 500), ‘single-search’ (i.e. a key attribute value used when sending a single search request to the single search server 500), or ‘geocode’ (i.e. a key attribute value used by the single search server 500 to indicate that a search is based on a previous suggestion result, and should be geocoded directly).

A key-value pair element in the search-filter element contains attributes: key and value. A key attribute (a string) in a key-value pair element holds a name that describes data stored in the value attribute of that key-value pair element. The key attribute is used to lookup a corresponding key-value pair element from a list of key-value pair elements. Correspondingly, the value attribute (a string) in a key-value pair element holds data described by the key attribute in that key-value pair element.

In accordance with the principles of the present invention, a key-value pair element (in the search-filter element of a single search query) contains any one of the following four key attributes: ‘name’, ‘category’, ‘source’, or ‘search-result-id’.

When the key attribute in a key-value pair element is ‘name’ (i.e. a name key-value pair), the value attribute in that key-value pair element contains contents of the single search box 110 (i.e. a user search query entered in to the single search box 110). A full search (i.e. a single search) is invoked on the value attribute in the name key-value pair element, when the result-style element in the search-filter element of that search query, has key attribute, ‘single-search’.

Moreover, when the key attribute in a key-value pair element is ‘category’ (i.e. a category key-value pair), the value attribute in that key-value pair element contains a category code for a selected category (i.e. a category selected from a list of categories 410 on the single search client 550). The category key-value pair element is embedded in the search-filter element of a search query when a user selects a category to search from a list of categories 410 on the single search client 550. If a category key-value pair element is embedded in the search-filter element of a search query, then the name key-value pair element in that search-filter element contains a value attribute with no text. A category key-value pair element may be provided by the single search server 500 as part of a search-filter element of a previous suggest-match.

In accordance with the principles of the present invention, when the key attribute in a key-value pair element of the search-filter element is ‘source’ (i.e. a source key-value pair), the value attribute in that key-value pair element describes an activity that initiated a single search. Activity information is used to apply certain boosts, when applicable. For instance, when handling a suggestion query, the single search server 500 embeds the source value stored in the search-filter element of that suggestion query in each suggest-match returned to the single search client 550. The value attribute in a source key-value pair element contains any one of the following potential string values: ‘main-screen’ (used when a user initiates a single search from the main application screen, regardless of current view: map mode or carousel), ‘place-screen’ (used when a user initiates a single search from the find a place screen 400), or ‘address-screen’ (used when a user initiates a single search from the enter an address screen 300).

Further, when the key attribute in a key-value pair element in the search-filter element is ‘search-result-id’ (i.e. a search-result-id key-value pair), the value attribute in that key-value pair element contains an opaque identifier used by the single search server 500 to retrieve a specific search result, as determined by a previous suggestion query. The search-result-id key-value pair element is only included in a search query when provided by the single search server 500 in the search-filter element of a suggest-match. The single search client 550 does not manipulate a search-result-id key-value pair element value in any way. Rather, the single search client 550 simply passes a search-result-id key-value pair element back to the single search server 500, as is.

In accordance with the principles of the present invention, a search query additionally includes a scheme attribute and a language attribute. The scheme attribute (a string) holds a specific data scheme (e.g. ‘tcs-single-search’ scheme) to use for a single search. Moreover, the scheme attribute in a search query may be different from a standard proxpoi ‘scheme’, since it describes a specific collection of map data, as well as POI data and dynamic content providers.

The language attribute in a search query is an optional 2 to 5 character string that specifies a language to use for a single search. If a language attribute is not specified in a search query, then US English is used to carry out that single search (by default).

The following depicts an exemplary search query template used to search non-suggestion queries, in accordance with the principles of the present invention.
(search-query (scheme tcs-single-search language en-US)
   (position (variant point)
      (point (lat |REPLACE_ME_WITH_LATITUDE| lon |REPLACE_ME_WITH_LONGITUDE|)))
   (iter-command (state “ ” command start number |AAAABQ==|))
   (search-filter ( )
      (pair (value “REPLACE_ME_WITH_PARTIAL_TERM” key name))
      (pair (value “main-screen” key source))
      (result-style (key single-search)))
   (want-premium-placement)
   (want-enhanced-pois)
(want-spelling-suggestions))

The following depicts an exemplary search query template used to search a suggested address or airport, in accordance with the principles of the present invention:
(search-query (scheme tcs-single-search language en-US)
   (position (variant point)
      (point (lat |REPLACE_ME_WITH_LATITUDE| lon |REPLACE_ME_WITH_LONGITUDE|)))
   (iter-command (state “ ” command start number |AAAABQ==|))
   (search-filter ( )
      (pair (value “REPLACE_ME_WITH_COMPLETE_TERM_FROM_SUGGESTION” key name))
      (pair (value “main-screen” key source))
      (result-style (key geocode))))

The following depicts an exemplary search query template used to search a suggested POI, in accordance with the principles of the present invention.
(search-query (scheme tcs-single-search language en-US)
   (position (variant point)
      (point (lat |REPLACE_ME_WITH_LATITUDE| lon |REPLACE_ME_WITH_LONGITUDE|)))
   (iter-command (state “ ” command start number |AAAABQ==|))
   (search-filter ( )
      (pair (value “REPLACE_ME_WITH_POI_NAME” key name))
      (pair (value “REPLACE_ME_WITH_POI_CATEGORY” key category))
      (pair (value “main-screen” key source))
      (result-style (key single-search)))
   (want-premium-placement)
   (want-enhanced-pois)
   (want-spelling-suggestions))

The following depicts an exemplary search query template for suggestions with coordinate in point format, in accordance with the principles of the present invention.
(search-query (scheme tcs-single-search language en-US)
   (position (variant point)
      (point (lat |QEDHo0gC4uc=|lon |wF1uphGFEA4=|)))
   (iter-command (state “ ” command start number |AAAABQ==|))
   (search-filter ( )
      (pair (value “irvine” key name))
      (pair (value “main-screen” key source))
      (result-style (key suggest))))

The following depicts an exemplary search query template with coordinate in GPS packed format, in accordance with the principles of the present invention.
(search-query (scheme tcs-single-search language en-US)
   (position (variant gps)
      (gps (packed |N7d7IgBfdUX+sSDxAX0AAAACAg==|)))
   (iter-command (state “ ” command start number |AAAABQ==|))
   (search-filter ( )
      (pair (value “9 laguna hills” key name))
      (pair (value “main-screen” key source))
      (result-style (key single-search)))
   (search-cookie (state “firstsearch=1” provider-id NAVTEQILAP))
   (want-premium-placement))

The following depicts an exemplary search query template for an along-my-route search with specific string, in accordance with the principles of the present invention.
(search-query (scheme tcs-single-search language en-US route-id
   |caC6RKhGQKmhJWhzD+ICHw==|)
   (position (variant point)
      (point (lat |QEDHo0gC4uc=|lon|wF1uphGFEA4=|)))
   (iter-command (state “ ” command start number |AAAABQ=|))
   (search-filter ( )
      (pair (value “Walmart” key name))
      (pair (value “ ” key category))
      (pair (value “main-screen” key source))
      (result-style (key single-search)))
   (want-premium-placement ( )
   (image (width |AAAAQA==| height |AAAAQA==| format png))))

The following depicts an exemplary search query template for an along-my-route search for fastPOI, in accordance with the principles of the present invention.
(search-query (scheme tcs-single-search language en-US)
   (position (variant gps)
      (gps (packed |N7d7IgBfdUX+sSDxAXOAAAACAg==|)))
   (iter-command (state “ ” command start number |AAAABQ==|))
   (search-filter ( )
      (pair (value AE key category))
      (pair (value ACC key category))
      (pair (value AA key category))
      (pair (value AH key category))
      (pair (value AIE key category))
      (pair (value AIC key category))
      (pair (value AID key category))
      (pair (value AKE key category))
      (pair (value AFC key category))
      (pair (value “main-screen” key source))
      (result-style (key single-search)))
   (want-premium-placement ( )
   (image (width IAAAAQA==| height IAAAAQA==| format png)))
   (route-corridor (distance |H24=| width |AfQ=|route-id |R/p7RXqrRC6JIE67hffOpw==|)))

The single search system supports along-my-route searches for POIs, only. An along-my-route search for POIs is defined as follows:

1. Matching POIs must be directionally ahead of a current location of a requesting client/user device.

2. Matching POIs must be within a 1 mile corridor of a searched route.

3. Matching POIs must be no more than 1 mile past a destination of a searched route.

Only certain POIs are returned for an along-my-route search. In particular, during an along-my-route search, the single search system is optimized to quickly return a subset of POIs for navigation maps. POI items returned for an along-my-route search are filtered to ensure that a requested number of POIs are evenly distributed along a specified distance.

In accordance with the principles of the present invention, search results (relevant to a specified criterion) are retrieved by the search servlet 510 and returned to the single search client 550 in a search response. A search response may contain a mix of data (e.g. geocoded street addresses, landmarks, points of interest, etc.) from a multitude of data sources.

In accordance with the principles of the present invention, the single search system uses the following data to generate search results for a search response: a search query, a current location of a requesting client/user device, a client product version, and a client device platform. The ‘scheme’ attribute in a search query controls which data is accessed for a particular client version and/or device platform.

Server-side result generation applies to addresses, POIs, POI categories, and airports. Client-side result generation applies to on-device data, i.e. favorites, contacts, and recent searches, and returns search suggestions, only.

Mixed results sets are supported within the present invention. For instance, a traditional POI, a fuel POI, and an address may all be combined as one single search result. A search result may include any type of POI match and any type of address match, including airports, Verizon (vzw) stores, gas prices, POIs enhanced with pictures, etc.

The single search system attempts to classify each search query entered in to the single search box 110. Query classifications include: address, POI name, POI category, airports, and unknown.

When a search query is classified as an address query, the single search server 500 returns a list of matching addresses to the single search client 550. Address searching is not subject to a limited search boundary. Rather, the single search system attempts to search for address matches anywhere in a specified country. When generating result candidates, a current location of a requesting client/user device is taken in to consideration to help disambiguate a search query.

An address result contains the following details: street number (or range), street name, city, state, zip code, distance, and a mailbox graphic (to indicate that the result is an address). The mailbox graphic is optional and dependent on the user experience (UX) design of a results screen 710. In particular, the mailbox graphic is supported on wide video graphics array (WVGA) and quarter video graphics array (QVGA) screens, and not supported on quarter common intermediate format (QCIF) and quarter quarter video graphics array (QQVGA) screens.

When a search query is classified as a POI name query, the single search server 500 returns a list of matching POIs to the single search client 550. POI name searches are not necessarily subject to a limited search boundary. Rather, the single search system attempts to find matching POIs anywhere in a specified country.

A POI result contains the following details: POI name, POI address (street number, street name, city, state, and zip code) (with up to 2 lines of display), distance from a center point of search, picture (if available), POI rating (i.e. a star rating) (if available), and a pin graphic (to indicate that the result is a POI).

POI ratings and pin graphics are optional and included in a POI result depending upon the user experience (UX) design of a results screen 710. Specifically, POI ratings and pin graphics are supported on wide video graphics array (WVGA) and quarter video graphics array (QVGA) screens, and not supported on quarter common intermediate format (QCIF) and quarter quarter video graphics array (QQVGA) screens.

On quarter common intermediate format (QCIF) (and smaller) screens, a full POI address is preferably displayed on one line, left justified, and scrollable when highlighted. On quarter video graphics array (QVGA) (and larger) screens, a POI address is preferably displayed on two lines, with street number and street name on one line, and city, state, and zip code on a subsequent line.

Fetching and rendering a picture for a POI result does not block display of the rest of the results screen 710.

When a search query is classified as a POI category query, the single search server 500 returns POI items (ordered by increasing distance from a current location of a requesting client/user device or a center of search) stored in a matching POI category to the single search client 550. A POI category query is a search query that maps directly to a POI category name (or a pre-defined category alias). For example, search query, ‘Japanese Restaurants’ is classified as a POI category query, when ‘Japanese Restaurants’ is a name of a category.

The single search server 500 parses a search term embedded in a user search query to determine if that search term matches a POI category name. When a search query maps directly to a POI category name (or a pre-defined category alias), the single search server 500 treats that search query as a category code. The single search server 500 then queries the search engine using the category code, rather than the user search query, so that all results returned to the single search client 550 are members of the searched POI category.

Search results for a POI category query are displayed in order of relevancy, from high relevancy to low relevancy, depending upon what category is selected. In accordance with the principles of the present invention, a category search screen (Restaurants and etc., except airports) is a single search box 110.

When a search query is classified as an airport search query, the single search server 500 returns a list of matching airports to the single search client 550. Airport searches are not necessarily subject to a limited search boundary. Rather, the single search system attempts to find matching airports anywhere in a specified country.

When a search query is classified as a gas station/gas price query, the single search server 500 returns a lowest gas price for regular gasoline grade, an average gas price for regular gasoline grade, and matching gas stations to the single search client 550. Each gas station result comprises the following data: gas station name, street address, city, state, ZIP, phone number, price of regular gasoline grade, and distance from center point of search. The single search client 550 displays gas price data in a results set instead of a ‘star’ rating when single search results contain gas stations with price information.

A fuel-price-summary element is returned in a results set when all results generated by the single search server 500 are gas stations, or when a user has initiated a gas price search (i.e. via a proxpoi query 606) on the single search client 550.

Search results are ordered by total relevance (i.e. a function of text relevance and location relevance), including distance. Most often search results are ordered by increasing distance from a current location of a requesting client/user device.

In accordance with the principles of the present invention, the following criteria may ‘boost’ a relevance factor awarded to a result item: exact match (i.e. search query==POI name), exact case, words in search query in same order as words in candidate result item, special characters in search query present in candidate result item, and inclusion of candidate result item in a preferred category. Candidate result items in certain preferred categories are awarded a higher relevance score than candidate result items in other non-preferred categories.

Search queries that are exactly one word long yield search results with POI names that contain this one word. All other relevance criteria being equal, search results with POI names that exactly match a search query are awarded a higher relevance score. For example, for user search query, “mcdonald's”, search result, “McDonald's”, is awarded a higher relevance score than search result, “McDonald's Corporate Office”

Moreover, a multi-worded search query yields search results with POI names that include one or more words embedded in that user search query. All other relevance criteria being equal, the more words a POI name has in common with a search query, the higher the relevance score awarded to that POI item. Further, search results that have POI names with words in the same order as a user search query are awarded a higher relevance score.

The single search system preferably returns a maximum of 100 search results for a search query. The single search client 550 is able to request up to 10 (configurable) search results at a time. If more than 10 search results are available for a search query, then an existing continuous scroll model is used to display results on a single page.

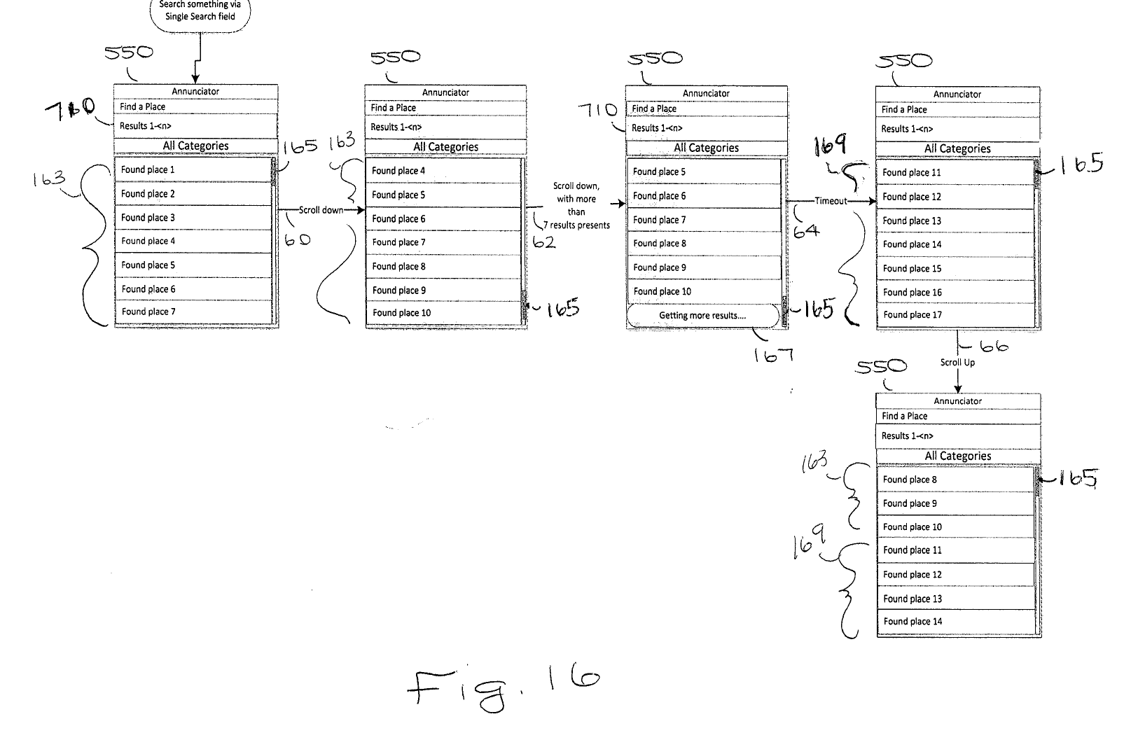

FIG. 16 depicts exemplary behavior of search results on the single search client, in accordance with the principles of the present invention.

As depicted in FIG. 16, the single search client 550 does not support pagination. Instead, search results are presented on a single page with a scroll 165. Initially, up to 10 search results (plus ads) 163 are fetched and presented on a results screen 710. As shown in step 60 of FIG. 16, the scroll 165 on the results screen 710 scrolls down to display all 10 search results 163.

As portrayed in step 62 of FIG. 16, when a user scrolls down and reaches the bottom of a results list, the single search client automatically fetches a next set of 10 search results from the single search server 500. While the single search client 550 is waiting for the single search server 500 to return a next set of search results, the single search client 550 displays an informational message (e.g. “Getting more results . . . ”) 167 at the bottom of the results screen 710. Once search results are returned to the single search client 550, the informational message (e.g. “Getting more results . . . ”) 167 is removed from the results screen 710 and the new set of search results 169 is appended to the previous set 163 displayed thereon, as shown in step 64. As depicted in step 66, the scroll 165 on the single search client 550 scrolls up and down to display all search results (163 and 169). The single search client 550 continues to respond to user actions, e.g., scroll, item selection etc., while waiting for a next set of search results to be returned.

To promote client responsiveness, the single search client 550 preferably pre-fetches a next set of up to 10 search results (and up to 1 advertisement), and holds these results in a client-side cache. For example, 20 search results are initially fetched for a single search, even though only 10 search results 163 are initially displayed on the results screen 710.

A search response for a single search contains the following elements: iter-result, proxmatch, suggest-match, file, and fuel-price-summary. In accordance with the principles of the present invention, an iter-result element is required in a search response, whereas proxmatch, suggest-match, file, and fuel-price-summary elements are all optional and included in a search response in accordance with unique circumstances of a given single search.

A search response contains anywhere from 0 to n proxmatch elements. Each proxmatch element in a search response represents a single search result (i.e. a POI result or a geocoded address result). A proxmatch element must contain a place element and may optionally contain a search-filter element, a premium-placement element, an enhanced-poi element, a poi-content element, and/or an unmappable element.

In accordance with the principles of the present invention, a place element in a proxmatch element contains location and/or POI data. A search-filter element in a proxmatch element contains additional search filter terms to add to a search query (if a user selects this item to expand). A premium-placement element in a proxmatch element indicates that the proxmatch element is a premium placement ad. An enhanced-poi element in a proxmatch element indicates that the proxmatch element is an enhanced POI. A poi-content element in a proxmatch element contains additional POI content, including advertisement-specific content. A poi-content element is included in a proxmatch element for premium placement ads and enhanced POIs. Premium-placement elements and enhanced-poi elements are empty.

A premium-placement pair element in a proxmatch element contains a key attribute and a value attribute. The following premium-placement pairs (e.g. premium-placement pairs supported by NAVTEQ ILAP) are valid for poi-content elements: an ad name premium-placement pair, a main text premium-placement pair, and a default user action premium-placement pair.

An ad name premium-placement pair contains key attribute, ‘ad-name’, and a value that specifies a name of an advertiser. A main text premium-placement pair contains key attribute, ‘main-text’, and a value that specifies a detailed description of an ad to be displayed on a detail screen. A default user action premium-placement pair contains key attribute, ‘default-user-action’, and a value that contains any one of the following acceptable variables: LANDING_PAGE, MAP, ROUTE, PHONE_CALL, or WEBURL.

An unmappable element (another empty element) is included in a proxmatch element when a place element in that proxmatch element does not refer to a physical location (i.e. a location unable to be navigated to or displayed on a map). When a place element is unmappable, an address stored in that place element may be partial/incomplete/empty. A point stored in an unmappable place element is ignored. In the current state of technology, only certain ads from Microsoft Bing are unmappable.

Every proxmatch element (POI and address) generated by the single search server 500 contains a distance attribute. A distance attribute represents a geographical distance between a location of a search result (i.e. a place element in a proxmatch element) and a center point of search, determined based on a location reference embedded in a corresponding user search query (if present). If a location reference is not provided in a user search query, then a current location of a requesting client/user device is used to compute geographical distance. A ‘Manhattan Distance’ (routable) may be considered for a future embodiment.

In accordance with the principles of the present invention, the single search system uses a spherical distance approximation to compute distance. In particular, if performance is acceptable, the single search system uses a ‘Great-Circle Distance’ formula to compute a spherical distance approximation for a distance calculation. Rather, if performance is not acceptable, the single search system uses a flat-surface formula to compute a spherical distance approximation for a distance calculation. Information regarding an additional formula that may be used to calculate distance within the present invention may be found at http://en.wikipedia.org/wiki/Haversine formula.

In accordance with the principles of the present invention, a search response may contain anywhere from 0 to n suggest-match elements. Suggest-match elements are included in a search response when the search-filter element in a corresponding search query contains result-style key, ‘suggest’.

A suggest-match element contains a search-filter element and a search suggestion for input text 810 entered in to the single search box 110.

The search-filter element in a suggest-match element contains filter criteria for a single search. When a single search is initiated on a suggest-match element (i.e. when a suggestion item is selected from a list of suggestions 800 displayed on the single search client 550), the single search client 550 sends a search query to the single search server 500 containing the search-filter element stored in that selected suggest-match item.

A suggest-match element in a search response additionally contains the following attributes: line1 (a string), line2 (a string), and match-type (a string). The line1 attribute in a suggest-match element contains a first line of text to be displayed for that suggestion item. For POI suggestions, the line1 attribute contains a place name and for address suggestions, the line1 attribute contains address text (as formatted by the single search server 500). The line2 attribute in a suggest-match element (if present) contains a second line of text to be displayed for that suggestion item. For POI suggestions, the line2 attribute contains an address associated with a POI (pre-formatted as text by the single search server 500). Finally, the match-type attribute in a suggest-match element contains a result type (e.g. address result, POI result, etc.) for that suggestion item. The single search client 550 uses the match-type attribute in a suggest-match element to determine an appropriate icon to display for that suggestion. Potential match-type values include: POI, address, airport, gas, and category.

In accordance with the principles of the present invention, a search response includes anywhere from 0 to n file elements. A file element contains a file (potentially an image) associated with a returned proxmatch element (i.e. a POI match). A file image may be common to multiple proxmatch elements.

A search response includes a fuel-price-summary element when all search results returned in that search response are gas stations. A fuel-price-summary element is never present in a search response that contains suggest-match elements (i.e. suggestions).

In accordance with the principles of the present invention, a search response always contains an iter-result element. An iter-result element holds an iteration state for a search response.

The following depicts an exemplary search response template, in accordance with the principles of the present invention.
(search-reply ( )
   (proxmatch (distance |Q52TvQ==|)
      (place (name “Dairy Queen”)
         (location (name “ ”)
         (address (city “Aliso Viejo” country USA airport “ ” county “ ” state CA str “27782 Aliso Creek Rd” xstr “ ” sa “ ” postal “92656” type street))
         (point (lat |QEDHkT6BRQ8=| lon |wF1uY51eSjg=|)))
         (phone (country “1” kind primary number “3620623” area “949”))
         (category (code AEF name “ ”))
         (category (code AEMH name “ ”)))
      (poi-content (id “46167”)
         (pair (value “1518” key brand-id))))
   (iter-result (state “10”)
      (exhausted)))

The following depicts an exemplary search response template for a search response with suggestions, in accordance with the principles of the present invention.
(search-reply ( )
   (suggest-match (line1 “321 Hollywood Blvd. Hollywood, CA 92101”)
      (search-filter ( )
         (pair (value “321 Hollywood Blvd. Hollywood, CA 92101” key name))
         (pair (value “main-screen” key source))
         (result-style (key geocode))))
   (suggest-match (line1 “Hollywood Video” line2 “789 Aliso Creek Rd. Aliso Viejo, CA 92656”)
      (search-filter ( )
         (pair (value “Hollywood Video 789 Aliso Creek Rd. Aliso Viejo, CA 92656” key name))
         (pair (value “dont_worry_about_this_value” key “search-result-id”))
         (pair (value “main-screen” key source))
         (result-style (key single-search)))
   (suggest-match (line1 “Planet Hollywood” line2 “123 Sunset Blvd. Beverly Hills, CA 90210”)
      (search-filter ( )
         (pair (value “Planet Hollywood 123 Sunset Blvd. Beverly Hills, CA 90210” key name))
         (pair (value “this_value_is_meaningless_to_client” key “search-result-id”))
         (pair (value “main-screen” key source))
         (result-style (key single-search))

Search results returned in a search response are displayed on a results screen 710 on the single search client 550. However, when a single search is initiated from the map screen 200, results are first presented on a map, along with an option to view results in list form. When a single search is initiated from the map screen, results are presented on a map even for suggested items expected to yield only one search result upon search.

Selection of a POI search result causes a standard POI detail screen for that selected POI item to be displayed on the single search client 550. A user can touch anywhere on a POI search result to invoke a corresponding detail screen.

A POI detail screen comprises the following attributes (when available): title (name of POI), address (street number, street address, city, state, zip code), approximate distance (from search center-point), directional heading (a compass ordinal), phone number, category(s), rating and rating count, hours of operation, picture, description, review count, additional properties (when available) (e.g. price, cuisine, parking options, hotel class, hotel rate, and amenities), and latitude and longitude.

In addition, attributes on a POI detail screen may be supervened by the following POI information (in the following order), when applicable: hours of operation, price, cuisines, description (customer message), special features, parking, attributes, and tips. Latitude and longitude are preferably the last two attributes displayed on a POI detail screen for a business.

Fetching and displaying a POI picture does not hold up display of a POI detail screen. POI data (including pictures), if already fetched, is held in a client-side cache, so that if at any point fetched POI data is subsequently requested, that POI data may be fetched from the cache. The client-side cache is preferably constrained by a pre-determined size limit.

Selection of a gas station/gas price search result causes a detail screen for that selected gas station/gas price item to be displayed on the single search client 550. A gas station/gas price detail screen contains the following data: gas station name, street address, city, state, ZIP, phone number, distance from center point of search, prices for each gasoline grade (when available), price for diesel (when available), price for ethanol (when available), and whether or not the gas station supports a charging station for electric vehicles (when available).

In addition to returning search results (POI results specifically) for a single search, the single search system also returns advertisements. The single search system supports an existing premium placement ad functionality. Ads are powered by an ad provider (e.g. Navteq Location Point Advertising (LPA) system).

In accordance with the principles of the present invention, the single search server 500 returns a premium placement ad with each set of local search results returned to the single search client 550 (including any set of search results returned in response to a “More Results” request). The single search server 500 does not retrieve premium placement ads for non-local searches (e.g., movie, event, traffic, weather, gas, and VZW store searches). Premium placement ads are not returned with address results.

Existing premium placement ad functionality is extended within the present invention to support integration of an existing location based advertising platform (e.g. aNavteq's ILAP system). In accordance with the principles of the present invention, the single search system uses an location based advertising platform to register and manage user identification and retrieve premium placement advertisement data. In particular, premium placement advertisement data is retrieved from a location based advertising platform server (e.g. Navteq's ILAP server).

In accordance with the principles of the present invention, end user checking performed by an existing location based advertising platform API, retrieves advertisements that are targeted geographically and based on a user search query. For instance, the ad server initially selects advertisement candidates based on location, and then further refines advertisement candidates using categories and/or keywords. For instance, after location is analyzed, a keyword parameter may be used to select an ad from a list of possible ad candidates. However, a keyword match does not always exist. In accordance with the principles of the present invention, even if no keyword match exists, an advertisement with matching location criteria is still returned to the single search client 550.

More specifically, the single search system retrieves a premium placement ad from the existing location based advertising platform, by specifying the following targeting criteria: userID, location, search term (optional, used in search term targeting), and search category (optional, used in category targeting). Location targeting criteria is provided to the location based advertising platform as a lat/lon pair. If a location associated with a search query is “In My Location”, then location targeting criteria for that search query is a current location of a requesting client/user device.

The single search server uses an ILAP retrieval request to retrieve an ad from the location based advertising platform. An ILAP retrieval request specifies a NIM category and a ‘what’ search term corresponding to a particular single search. If the integrated location based advertising platform returns no ad in response to an ad retrieval request or if the location based advertising platform returns a vantage point ad only, then the single search server 500 does not return any ad to the single search client 550 and the single search client 550 displays local search results, only.

Category targeting is used to retrieve advertisements relevant to a category selected from a list of categories on the single search client 550. Category targeting is performed when a category is selected to initiate a single search, and no search query is entered in to the single search box 110. In accordance with the principles of the present invention, the name of a category selected to initiate a single search is used to create a keyword parameter for advertisement retrieval. For instance, exemplary category targeting criteria used to select an advertisement relevant to selected category, ‘Restaurants’, includes the following: What=“ ” (i.e. no search query is entered in to the single search box), Category=‘Restaurants’ (i.e. name of category selected to initiate a single search), and Keywords=‘Restaurants’ (i.e. keyword used for category targeting).

A keyword parameter may contain one or more words. All categories selected to initiate a single search are included in a keyword parameter. For example, if What=“ ” (i.e. no search query is entered in to the single search box), and Category=“Gas” and “Automotive” (i.e. two categories selected), then Keywords=“Gas Automotive”. For this exemplary single search, the location based advertising platform returns ad targeting on “Gas”, “Automotive”, or “Gas Automotive”, and puts a higher preference on ads containing exact match, “Gas Automotive”. A keyword parameter is not used to retrieve ads when a single search is initiated on ‘All Categories’ and a search query is not entered in to the single search box. For example, if What=“ ” (i.e. no search query is entered in to the single search box) and Category=“All Categories”, then Keywords=“ ”, indicating that a keyword parameter is not part of the end user checking process used to retrieve an advertisement for this single search.

location based advertising platform (e.g. Navteq's ILAP system) supported within the present invention preferably accepts all keyword parameters and attempts to select advertisements relevant to a user search query. If a single search is initiated via a search query (i.e. a ‘What’ field) only, then that search query is used to construct a keyword parameter for advertisement retrieval. For example, if What=‘Burger King’ and Category=‘All Categories’, then Keywords=‘Burger King’.

A keyword parameter may contain multiple keyword phrases, separated by commas (,). Multiple keyword support allows a single search to be initiated on a POI category and a search query. The location based advertising platform server supported within the present invention preferably uses all phrases in a keyword parameter to search for a matching advertisement. For example, if Category=“Gas”, and What=“Shell”, then Keywords=“Gas, Shell” (i.e a keyword parameter based on selected category and search term, category and search term being separated with a comma).

In accordance with the principles of the present invention, the single search server 500 returns one advertisement for each set of local search results returned to the single search client 550. In particular, the single search server 500 performs POI search and ad retrieval concurrently and returns combined results (POI and ad results) to the single search client 550. A wait threshold for a premium placement ad is 1 second.

In accordance with the principles of the present invention, an advertisement returned to the single search client 550 contains ad details and storefront details (e.g., storefront location (lat/lon), name, and address). In particular, each premium placement ad retrieved from the location based advertising platform comprises the following data: ad name, intro text, intro icon, main text, ad storefront (if multiple storefronts apply, then only the first storefront is returned in an advertisement), and lat/lon.

Details displayed for each ad storefront include: name, address, and phone number. If an override phone number is available for a premium placement ad, then that override phone number is returned to the single search client 550 instead of the storefront phone number. Hours of operation are not displayed for a premium placement ad. A premium placement ad does not contain a distance value.

In a results set, a premium placement ad displays an advertiser's name on a first line of display and a storefront address on a second line of display. An intro icon and additional text displayed for a premium placement ad are not separated by vertical lines on a results screen 710. Moreover, a premium placement ad is preferably displayed with a yellow background.

A premium placement ad is preferably positioned at an indexed location in a results set returned to the single search client 550, and displayed (by default) at this indexed location on a results screen 710. For example, a premium placement ad may be returned as a first item in a results set sent to the single search client 550, and subsequently displayed (by default) as the first item on a results screen 710.

A premium placement ad is displayed using an intro icon when returned with local search results displayed (as pins) on a map. Selection of a premium placement ad on a map causes intro text and an instructional phrase (e.g. “Click for more details”) for that ad to be displayed in a balloon on the map. For example, a name of a location and an identifying phrase (e.g. “Sponsored AD”) may be displayed in a balloon on a map to represent a premium placement ad. Selection of a balloon representing a premium placement ad causes a POI detail screen for that selected ad to be displayed on the single search client 550.

Registered users may interact with advertisements displayed on a results screen 710. In particular, if an ad is selected on a results screen 710, then a POI detail screen for that selected ad is displayed on the single search client 550. Any option (e.g. navigate, map, add to favorites, share, call, or search) displayed on the POI detail screen for a selected ad may be selected to prompt the single search client 550 to perform that action.

The single search system collects and stores analytic data so that mobile application usage may be profiled. In accordance with the principles of the present invention, the single search system uses the location based advertising platform to track impressions and interactions of users with premium placement ads.

In particular, the single search server 500 uses the existing location based advertising platform to register and manage user identification. In particular, an ILAP UserID is stored on the single search client 550 and the single search server 500. If an ILAP UserID is not present on the single search client 550, then the single search client 550 requests a UserID from the single search server 500. If a UserID is not present on the single search server 500, then the single search server 500 requests a new UserID from the location based advertising platform (e.g. Navteq LPA version 2.3).

Whenever a premium placement ad is retrieved from the server, the single search system logs an ‘impression’ event. In addition, user actions ‘click to detail’, ‘click to map’, ‘click to call’, ‘click to navigate’ and ‘click to favorite’ are also logged and reported to the server. In accordance with the principles of the present invention, the “click to share” event is logged in the single search system but not sent to the location based advertising platform, since the location based advertising platform does not support an action type applicable to a “click to share” event. If a premium placement ad is added to “recent searches” or “favorites”, then that premium placement ad is added as a standard POI, and use of the POI from “recent searches” or “favorites” is not logged. Logs maintained for each event preferably contain the same information as logs maintained in an existing AtlasBook Navigator v5.

In accordance with the principles of the present invention, advertisement tracking information, specific to a particular ad provider (and required only for reporting ad activity back to that ad provider), is stored in a vendor-specific ‘golden cookie’. ILAP specific information stored in a ‘golden cookie’ contains the following data: search location, campaign ID, storefront ID, and ILAP user ID. Events are preferably reported from client to server in the same manner events are reported in the existing AtlasBook Navigator v5 (i.e. the server reports an event to the location based advertising platform server when received from the client).

The following user actions are supported within the present invention: LANDINGPAGE (click to detail), MAP (click to map), ROUTE (click to navigate or preview), PHONECALL (click to call), WEBURL (click to web URL), IMPRESSION (ad impression), and ARRIVAL (user arrival at advertiser's storefront). Coupon actions are not included in this list of user actions.

Every time an IMPRESSION or a LANDINGPAGE user action is reported to the location based advertising platform, a 3^{rd} party tracking universal resource locator (URL) for the reported action is invoked via an HTTP GET request. A 3^{rd} party tracking universal resource locator (URL) is invoked at the same time the user action is reported to the location based advertising platform.

An advertisement provided by the location based advertising platform (e.g. the Navteq ILAP system) indicates default actions that may be performed on that advertisement. Default actions include: LANDINGPAGE, ROUTE, PHONECALL, WEBURL, and MAP. Coupon actions are not included in this set of default actions.

Selection of an advertisement (an impression) automatically invokes a default action. The single search system does not assume that a default action is clicking to the detail screen.

An ad landing page includes a link for a web universal resource locator (URL), when available. Selection of a web universal resource locator (URL) on a landing page triggers a relevant advertiser's site to be displayed in a web browser on a requesting client/user device.

Prerequisites required to enable a successful local search request and download with advertisements, include: a network to allow the single search client 550 to communicate with the single search server 500 (to download search results and deliver analytics), relevant POI data stored on the single search server 500, and an affiliate account setup between the single search server 500 and an existing location based advertising platform. Once prerequisites are fulfilled, the single search server 500 may retrieve 10 search results from Apache Solr™ 560 and 1 premium advertisement from the location based advertising platform server for each single search initiated on the single search client 550. Search results and an advertisement are returned to the single search client 550 in a search response (a premium ad is preferably the first result returned in a search response). In accordance with the principles of the present invention, results are packaged by the single search server 500 so that the single search client 550 does not have to do any sorting. The single search server 500 downloads a new ad server whenever more search results are requested for identical search criteria.

If results retrieved for a search query contain only premium placement ads, then the single search server 500 does not return any data to the single search client 550, and the single search client 550 displays an informational message (e.g. ‘NO RESULTS FOUND’) to this accord. Similarly, if results retrieved for a search query contain no premium placement ads, then only POI search results are returned to the single search client 550.

Moreover, to enable user action tracking, a network is established to allow the single search client 550 to communicate with the single search server 500 to deliver analytics. In accordance with the principles of the present invention, the single search client 550 sends an analytics request to the single search server 500 for each user action performed on an advertisement. In response to an analytics request, the single search server 500 extracts ad details, action type, and a client's ILAP user id from a golden-cookie embedded therein, and logs details in a monitoring database. The single search server 500 then sends an analytics response with status to the single search client 550.

In accordance with the principles of the present invention, an analytics-event element is a container element for all device analytic events used to record and track user interaction within the single search system. The analytics event element must include a session-id attribute unique to a given device and one (and only one) specific event element. Each event element included in an analytics-event element contains the following attributes: a timestamp (in GPS time), a unique id and a session id.

The timestamp attribute in an analytics-event element contains a timestamp for a corresponding event (in GPS time). The unique id attribute in an analytics-event element contains a unique identifier for a corresponding event. The unique id attribute is unique amongst all events of all types within a current session (identified by the session id attribute), and is preferably a sequential value, incremented for each uploaded event. The session id attribute in an analytics-event element is a unique session identifier (e.g. a timestamp) assigned to a given client. For a mobile client, a session corresponds to an application session (i.e., time elapsed between application startup and application shutdown).

Table 6 depicts a list of event elements that may be included in an analytics-event element. Each analytics-event element contains ONE and only one of the event elements listed in Table 6.

TABLE 6

| Type | Description |
|---|---|
| search-query-event | Local search event |
| search-detail-event | Display search detail event |
| impression-event | Display impression event |
| map-event | Display map event |
| place-message-event | Place message event |
| facebook-update-event | Update facebook event |
| call-event | Phone call event |
| add-favorites-event | Add to favorites event |
| route-request-event | Route request event |
| route-reply-event | Route reply event |
| route-state-event | Route state change event |
| gps-probes-event | GPS probe event |
| feedback-event | Feedback from user. Report a concern |
| | feature. |
| app-error-event | Application error event. Only errors |
| | reported to the user. |
| weburl-event | Viewed the URL associated with an ad. |
| arrival-event | Successfully arrived at the destination |
| | specified by an advertisement. |

In accordance with the principles of the present invention, a web URL event is an event that occurs when a user clicks on a web URL for an advertisement. The web URL event contains an analytics-event-place element, which holds a place associated with that web URL event.

An arrival event is an event that occurs when a user arrives at a destination associated with an advertisement. An arrival event contains an analytics-event-place element, which holds a place associated with that arrival event.

A search query event is an event that occurs when a local search is initiated on the single search client 550. The search query event is triggered by a local search request for a first page of search results. A search query event may contain the following optional elements: search-filter, point, and search-event-cookie. The search-filter element in a search query event contains filter criteria for a proximity search, the point element contains a center for a proximity search, and the search-event-cookie element contains information to be sent back to the single search server 500 when reporting a search event. A search-event cookie may contain a search-event-cookie returned in an associated proxpoi reply (if one has previously been returned).

Moreover, a search query event contains the following attributes: scheme (a string), input-method (a string), and asr-provider-session-id (a string). In accordance with the principles of the present invention, the scheme attribute in a search query event comprises a POI data scheme to use, the input-method attribute (optional) comprises a user input method of search, and the asr-provider-session-id attribute indicates that the single search has been initiated via automatic speech recognition (ASR). The asr-provider-session-id may contain a provider-session-id returned in an asr-stream-reply (if one has previously been returned). The input method attribute contains any one of the following possible values: ‘screen’ (screen/keyboard input), ‘voice’ (voice input), ‘suggestion’ (user selects a suggestion), ‘sort’ (user selects a new sort order of a currently displayed list), and ‘more’ (user selects prey/next page).

In accordance with the principles of the present invention, the single search system supports a conventional find a place feature and a conventional enter an address feature. These conventional features (i.e. the find a place feature and the enter an address feature) are supported within the present invention, in addition to the inventive single search feature, since current subscribers typically expect these features, a portion of users prefer a path driven user interface, and a portion of users like the category browsing capability offered on the existing find a place screen 400.

The find a place screen 400 supported within the present invention encompasses a single search box 110, as opposed to a conventional search box, and supports search suggestions and a category list 410. However, the category list 410 on the find a place screen 400 does not serve as a filter. Instead, selection of a category is treated as a distinct operation of search using a search term.

When the single search system is accessed from the find a place screen 400, a hint is sent to the single search system, informing the system to accord a higher relevance score to POI results. Requirements for POI results returned in response to a search initiated from the find a place screen 400 are the same as requirements for POI results previously described herein.

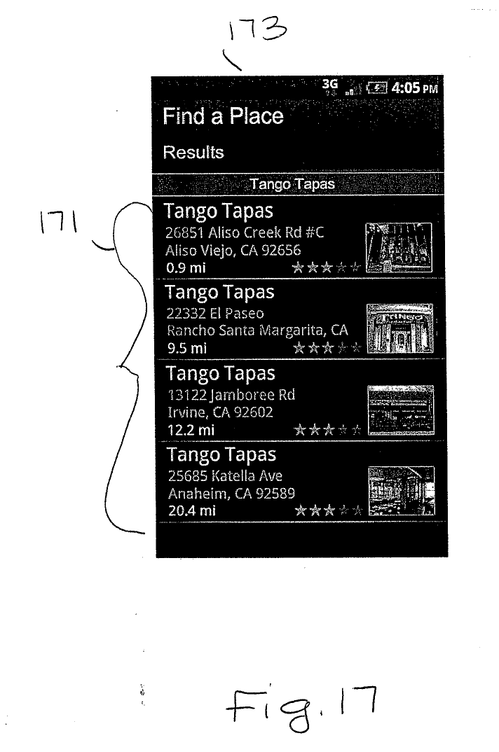

FIG. 17 depicts an exemplary find a place results screen, in accordance with the principles of the present invention.

As depicted in FIG. 17, a list of business locations 171 is displayed on a find a place results screen 173 in response to a conventional find a place request.

The enter an address screen 300 supported within the present invention encompasses a single search box 110, as opposed to a conventional search box, and supports search suggestions. Address search results and address details retrieved for an enter an address request are geo-coded.

When the single search system is accessed from the enter an address screen 300, a hint is sent to the single search system, informing the system to accord a higher relevance score to address results. Requirements for address results returned in response to a search initiated from the enter an address screen 300 are the same as requirements for address results previously described herein.

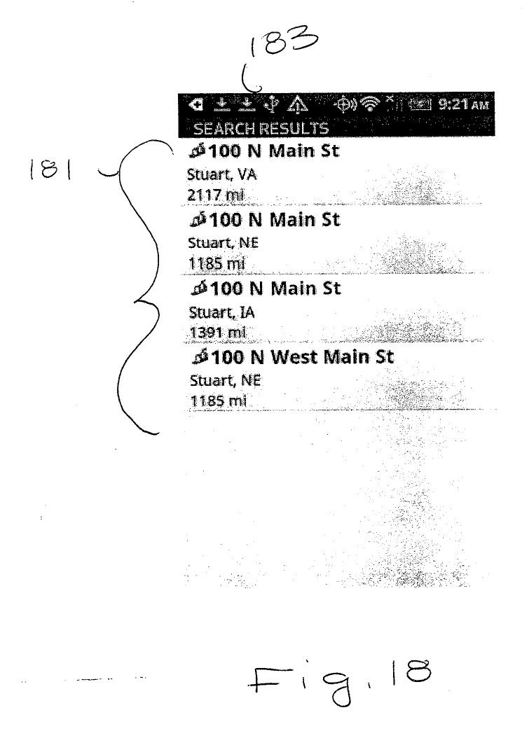

FIG. 18 depicts an exemplary enter an address results screen, in accordance with the principles of the present invention.

As depicted in FIG. 18, a list of addresses 181 is displayed on an enter an address results screen 183 in response to a conventional enter an address request.

The enter an address screen 300 automatically sets focus inside the single search box 110 when a keyboard 310 is launched. When the microphone button positioned next to the single search box 110 on the find an address screen is selected, text is automatically returned by the automatic speech recognition (ASR) server and searched.

In particular, if focus (a cursor 910) is inside the single search box 110 (meaning that either a user has pressed the single search box 110 or focus has been placed inside the single search box 110 automatically) and an ASR button (i.e. a microphone button) positioned next to the single search box 110 is selected, then the single search system requests a verbal search query and automatically initiates a single search on that verbal search query. An appropriate next screen (e.g. a search results list or details screen) containing relevant search results is subsequently displayed.

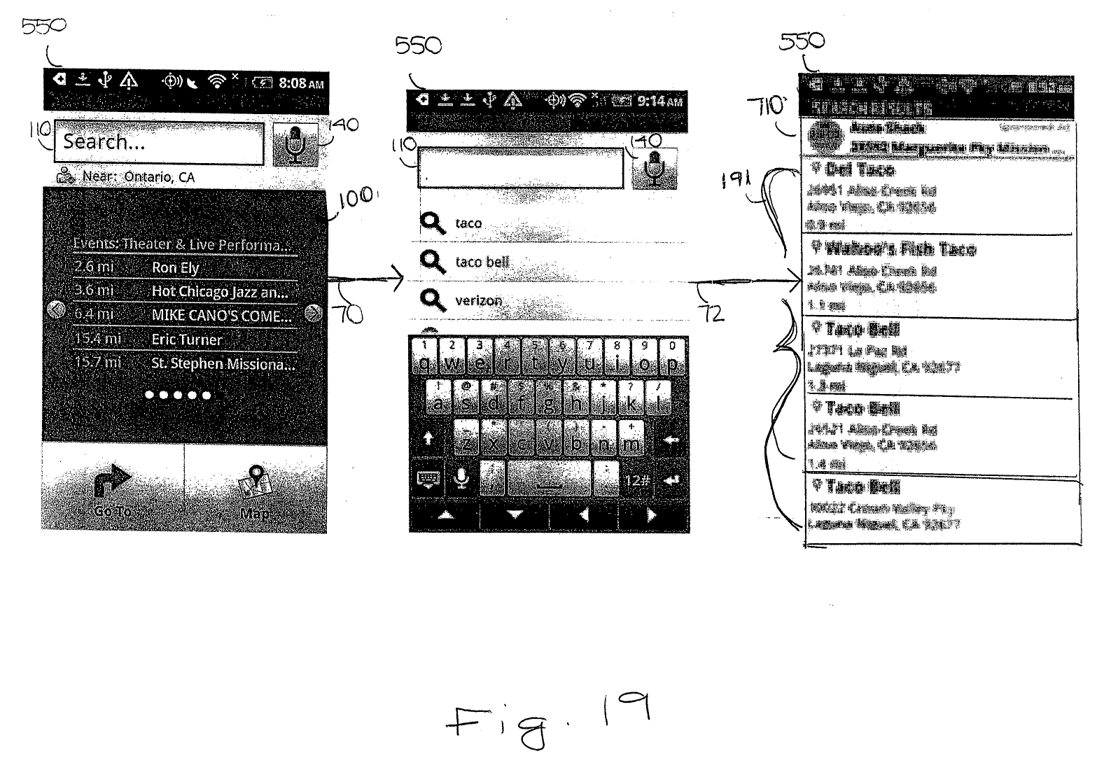

FIG. 19 portrays a call flow depicting an exemplary single search via automatic speech recognition (ASR), in accordance with the principles of the present invention.

In particular, a main screen (in carousel view) 100 is initially displayed on the single search client 550. As shown in step 70, focus is placed inside the single search box 110 (automatically or as a result of a user pressing inside the single search box 110). The ASR button 140 is pressed while focus is set inside the single search box 110, and a user speaks in to a microphone on a client/user device. User input is treated as a verbal search request and a results screen 710 containing relevant search results 191 is automatically displayed on the single search client 550, as depicted in step 72.

Certain screens do not automatically set focus inside the single search box 110. On such screens, if focus is set inside the single search box 110 and an ASR button (i.e. a microphone button) positioned next to the single search box 110 is pressed, then text is returned by the automatic speech recognition (ASR) server and automatically searched. In most cases, search via automatic speech recognition (ASR) returns a search results list or a detail screen.

The present invention also supports a conventional airports feature and a conventional recent searches feature.

In accordance with the principles of the present invention, the single search system generates reports that detail search query counts and result relevancy. For instance, the single search system generates the following search query reports on a periodic basis: number of search requests report, top 1000 POI search terms report, and top 20 search categories report. Additional reports include: number of requests classified as a POI search request report, number of requests classified as an address search request report, and number of requests that include a special instruction term (e.g. ‘Go’) in the search query report. Moreover, the number of requests classified as a POI search request report is broken down in to the following reports: number of requests classified as a category search report, number of requests classified as a gas search report, number of requests classified as a VZW store search report, number of requests classified as an along-my-route search report, and number of requests where location is set to ‘current location’ report.

The single search system also generates result relevancy reports. Result relevancy reports contain a number of requests performed for each of the following calls to action: navigate, map, share, call, and find nearby. The single search system uses result relevancy reports to judge the relevancy of search results returned to the single search client 550. Data accumulated in reports generated by the single search system may be broken down according to the following: start date/end date, day part (hour of day), device platform, device model, and product version (client and web companion).

The present invention introduces a new search capability. A search-capability describes a search technology used, as well as an accompanying premium placement vendor. In accordance with the principles of the present invention, a search-capability element used within the present invention preferably contains key attribute, ‘search-capability’, and value, ‘AD:ILAP;POI:TCS-SS’. Exemplary future search-capability values may include: ‘AD:ILAP;POI:TCS-SB’ (for searchbuilder POI with Navteq ads), ‘AD:BING;POI:BING’ (for Bing search+ads) and AD:DOUBLECLICK;POI:TCS-SS' (for single search+new ad vendor).

For privacy purposes, search logs are not tied to any piece of personally identifiable information, such as a mobile directory number (MDN). Instead, an ‘annonymized’ mobile directory number (MDN) is used to record user activity within the present invention. Search logs maintained in the single search system are removed after 12 months (i.e. no search logs are retained beyond a 1 year period).

The single search box 110 feature is tested on both the single search client 550 and the single search server 500 using automated black box and white box testing.

In accordance with the principles of the present invention, a suggestion test case is comprised of partial term searches based on real search terms. To reduce the positive impacts of results-caching, test cases use partial search terms that do not overlap one another.

The following depicts an exemplary base template packing system (TPS) s-expression for a suggestion query, in accordance with the principles of the present invention.
(search-query (scheme tcs-single-search language en-US)
   (position (variant point)
      (point (lat |REPLACE_ME_WITH_LATITUDE| lon |REPLACE_ME_WITH_LONGITUDE|)))
   (iter-command (state “ ” command start number |AAAABQ==|))
   (search-filter ( )
      (pair (value “REPLACE_ME_WITH_PARTIAL_TERM” key name))
      (pair (value “main-screen” key source))
      (result-style (key suggest)))
   (want-enhanced-pois))

Partial search terms used within the present invention fall within lengths presented in Table 2.

TABLE 2

| | Term Length (# | | Term |
|---|---|---|---|
| Test case name | characters) | TPS | Example |
| SSB-Suggestions-1 | 1 | 45 100 | ‘a’ |
| SSB-Suggestions-3 | 3 | 30 60 | ‘ali’ |
| SSB-Suggestions-6 | 6 | 15 40 | ‘aliso v’ |
| SSB-Suggestions-10 | 10 | 10 25 | ‘aliso viejo’ |

Spaces embedded in search terms used in suggestion test cases do not count as characters for checking length. Also, a space is never the last character of a search term used in a test case.

Table 3 depicts a template packing system (TPS) breakdown of exemplary test cases performed on the single search system.

TABLE 3

| | | Result | |
|---|---|---|---|
| Test case name | TPS | Style | Term Example |
| SSB-POI | 5 15 | single- | “burger king” |
| | | search | |
| SSB-Category | 3 15 | single- | “burger king” |
| | | search | |
| SSB-PtAddr | 7 15 | single- | *Must use real address |
| | | search | |
| SSB-PartialAddr | 3.5 10 | single- | ‘main st santa ana’ |
| | | search | |
| SSB-Suggested- | 5 15 | single- | *Must use full POI name as |
| POI | | search | returned from suggest query. |
| | | | *Must use real POI ID |
| SSB-Suggested- | 1 3 | geocode | “Main St. Santa Ana, |
| Addr | | | CA 92661” |
| SSB-Suggested- | 0.5 3 | geocode | “Los Angeles International |
| Airport | | | Airport” |

The single search server 500 provides a method of clustering and/or high availability. In particular, the single search system is architected to be available 99.999% of the time.

The inventive single search system has a higher performance (in terms of search functionality) than that of the existing SearchBuilder 540. In particular, for search queries processed by the single search server 500, an average server-side result generation wait_time of less than or equal to 750 milliseconds is preferably maintained, and a 95^{th} percentile wait_time of less than 2000 milliseconds is preferably maintained, per monitoring database table, tps_servlet_reply_event.

Moreover, for suggestion queries processed by the single search server 500, an average server-side result generation wait_time of less than or equal to 250 milliseconds is preferably maintained, and a 95^{th} percentile wait_time of less than 750 milliseconds is preferably maintained, per monitoring database table, tps_servlet_reply_event.

Search suggestions sourced from client side data are preferably available in under a predetermined number of milliseconds.

If the single search server 500 is restarted for any reason, a cache warm-up mechanism is employed. The present invention is capable of supporting 25 search queries and 100 suggestion queries per second, as measured by standard load test tools.

Several load impacting changes are implemented within the present invention. Notably, the single search system boosts system performance (in comparison to conventional search system performance) by replacing a conventional remote web service call to Bing with an internal call to Apache Solr™ 560 (Apache Solr™ 560 performs better than Bing). In addition, the single search system fetches advertisements via a remote service independent of a query search system, which places a potential negative impact on POI search performance. Further, along-my-route searches, gas price searches, and freeform geocode queries are proxied through the inventive search servlet 510, which potentially impacts system performance (along-my-route searches and gas price searches do not incur much processing overhead in search). System performance may be further impacted as a result of additional load incurred by geocode, due to false positives returned for searches incorrectly categorized as address searches.

The single search system improves user experience through improved search categorization, dynamic feedback, and a substantial performance boost over the existing searchbuilder system 540.

Several considerations and constraints are placed on the suggestion functionality introduced within the present invention. In particular, the single search system requires that suggestion content never be blocked based on assumptions built upon partial input. For instance, though a query for ‘pizza’ may seem like a request for a pizza restaurant category, it is possible that ‘pizza’ is just an in-progress substring of some superset of user input. Hence, the inventive single search system does not block suggestions based on partial query strings (e.g. ‘pizza’). For example, in exemplary search query ‘pizzaros magic palace’, category name ‘pizza’ is just a small substring of user input.

Moreover, remote calls made by the inventive search servlet 510 impact the performance of the inventive suggestion functionality. Hence, a no inter-servlet query constraint is placed on the suggestion functionality to assure that suggestions are especially responsive to a requesting client/user device. Also, being that suggestions need not contain full detailed information, information available to the search servlet 510 is sufficient for fulfilling suggestion queries.

The single search system also applies the theory: ‘good enough really is’ to the inventive suggestion functionality. Being that suggestions cover a wide swath of data based on partial input, the present inventors identify no need to pre-fetch additional information when suggestion line1 and/or line2 need not be filled.

The inventive suggestion functionality is also required to provide and use ‘shortcuts’. In accordance with the principles of the present invention, a suggest-match element contains a search filter that is echoed back to the search servlet 510 once a suggestion is selected. As new data corpora are added to the single search system, shortcuts enabled by the inventive suggestion system provide a performance boost for an actual search on a suggestion item, should that suggestion item be selected. For example, the inventive single search system provides a geocode result_style element in a suggestion for a street name, so that the single search server 500 may skip filter logic and a remote call to Apache Solr™ 560, whenever that street suggestion is selected.

The inventive suggestion functionality is also required to keep suggestion line1 and line2 generic/freeform. In accordance with the principles of the present invention, to keep the suggestion system flexible, the single search system disallows a client to make assumptions based on text displayed in suggestion line1/line2. A flexible suggestion system makes backward and forward compatibility easier to maintain.

In accordance with the principles of the present invention, the single search server 500 provides a packaging solution that ensures data consistency with a simple deployment process (preferably a centralized method like Yum/RPM). The packaging solution identifies what is currently installed, without having to guess based on prior MOP procedures. Data packages have an official release process with quality assurance (QA) signoff, similar to the process with which quarterly map data is currently released.

The single search server 500 provides quick recovery via a reinstall of data or backup/restore. If a reinstall takes too long, then a rotating snapshot method is preferred (for systems that are constantly changing, e.g., feeds). Quick recovery is necessary in the event of data corruption. The single search server 500 additionally provides a method for quick upgrades and rollback.

In accordance with the principles of the present invention, the single search server 500 provides a method of system monitoring. In particular, a simple network management protocol (SNMP) and a Java management extensions system (JMX) are available for detailed information gathering. The monitoring method used within the present invention includes any network ports that require availability for proper system functionality (admin ports need not be monitored, nor do unused supplemental ports/services), and any other critical services that software depends on. The monitoring method supported within the present invention includes the following metrics: gauge system health (such as transactions per second), query latency, java heap usage, cache misses, error counters, etc. Once metrics are understood, thresholds are established for of warning and critical levels. A method of tracking software error logs is also desired. In most cases, tracking of software errors is achieved via syslog. Software errors are typically tracked using a standard syslog mechanism.

Existing monitoring database table, search-events, is used to log/report data within the single search system. In accordance with the principles of the present invention, the following fields are added to existing monitoring database table, search_events: Apache Solr™_wait_time, uber_wait_time, uber_result_used, proxpoi_wait_time, geocode_wait_time, geocode_result_count, search_lat, search_lon, and result_types.

In particular, inventive field Apache Solr™_wait_time is added to existing monitoring database table, search-events, to represent how long the inventive search servlet 510 has blocked while waiting for Apache Solr™ 560.

Apache Solr™_wait_time uses the same units/types as conventional wait_time fields maintained within existing monitoring database table, search_events. Moreover, inventive field uber_wait_time is added to existing monitoring database table, search_events, to represent how long the search servlet 510 spent in uber lookups. Uber_result_used is an inventive text field used to hold a city/state/zip combination chosen from uber results. In accordance with the principles of the present invention, inventive field proxpoi_wait_time holds the amount of time the search servlet 510 waited for proxpoi servlet 520 calls. Inventive field geocode_wait_time holds the amount of time the search servlet 510 waited for geocode lookups. Inventive field geocode_result_count holds the number of results returned from the geocode servlet 530. Inventive fields search_lat and search_lon hold a search center used to conduct a search when a current location of a client/user device is not used for search. Further, inventive field result_types is a bit field that holds a bit representation of result types returned to the single search client 550. Bit field result_types preferably uses the following bit representation: 1 bit=suggestion(s); 2 bits=POI; 4 bits=non-local landmark; 8 bits=StreetAddress; 16 bits=city+state+zip; 32 bits=airport; 64 bits=gas; and 128 bits=VZW stores.

For example, a suggestion response including POI suggestions and one state-only suggestion, results in a result_types bit value of 19 bits (1 bit (suggestions)+2 bits (POI)+16 bits (city+state+zip)=19 bits). Moreover, a search response comprising POI search results and one state-only search result (a result response identical to the previous exemplary response, minus result_style=‘suggest’), results in a result_types bit value of 18 bits (2 bits (POI)+16 bits (city+state+zip)=18 bits).

CityGrid Media reporting requirements are implemented within the present invention.

Points of interest (POI) used within the present invention are preferably sourced from the following data providers: Navteq, CityGrid Media (aka City Search), and OpenTable. Gas stations are preferably sourced from Oil and Petroleum Information Service (OPIS).

Since POI data is sourced from multiple vendors, the present invention minimizes the occurrence of duplicate POIs by way of a de-duplication mechanism. The de-duplication mechanism used within the present invention combines (according to Sinsearch-5.3) records that contain an identical latitude, longitude, and POI name, and additionally combines (according to Sinsearch-5.3) records that contain an identical POI name, street number, street address (street1) and postal data.

The de-duplication mechanism used within the present invention combines POI records by merging NAVTEQ records with available CityGrid records, and/or other records, and by filling in any additional fields from CityGrid records not present in NAVTEQ records. In accordance with the principles of the present invention, all NAVTEQ fields are retained, not overwritten.

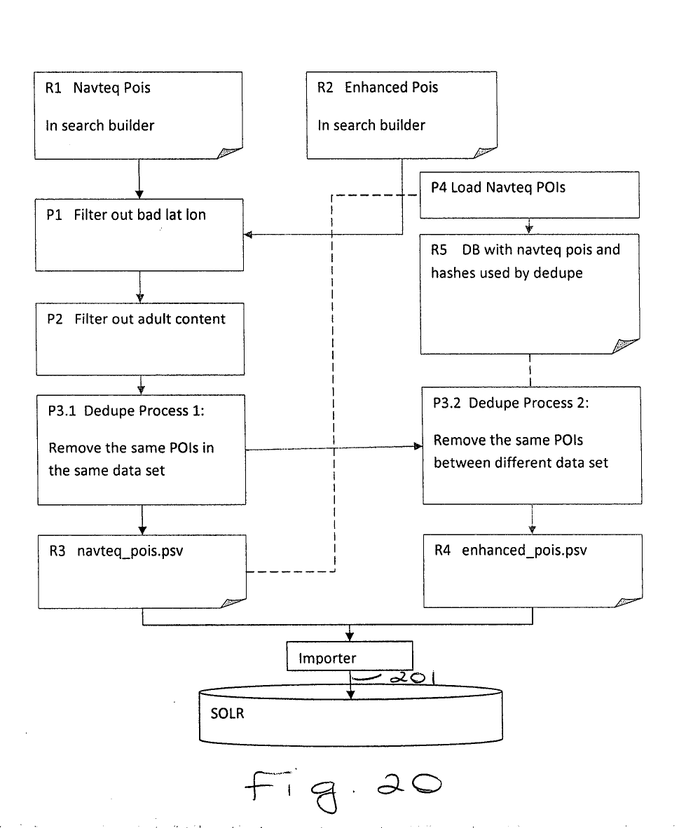

FIG. 20 depicts an exemplary de-duplication mechanism used to remove duplicate POIs from source data, in accordance with the principles of the present invention.

As depicted in steps R1 and R2 of FIG. 20, POI data is first queried from searchbuilder (oracle) 540 and dumped to pipe-delimited flat files (i.e. data undergoes a dumping process). Data files are then processed by a data preprocess (p1, p2 and p3). During a data preprocess (steps P1, P2, P3), POI data is passed through an adult content filter P2 and a bad lat lon filter P1, and subsequently processed by a dedupe process P3. The present invention uses an sqlite based dataset (e.g. ReadOnlySqliteDataSet) to save and index POIs when deduping Navteq and CitySearch data. As depicted in step 201, POI data is imported to Apache Solr™ 560 following completion of a data preprocess.

In accordance with the principles of the present invention, the single search system accommodates POI data updates at a set of predetermined frequencies. In particular, Navteq POI data is updated quarterly with every quarterly map update, CityGrid Media POI data is updated once a day (nightly), OpenTable Restaurants POI data is updated daily, and OPIS POI data is updated once a day (nightly).

In accordance with the principles of the present invention, CityGrid Data supersedes Navteq data (as CityGrid data generally maintains more content for each POI stored therein), and OpenTable data supersedes both Navteq and CityGrid data.

The system architecture of the inventive single search system is preferably based on a conventional NAVbuilder Server client/server framework that uses python servlets (i.e. server-side programs that receive and respond to requests from users) to handle requests from a remote client application.

An existing web companion is enhanced to incorporate use of the single search system.

Existing ‘Maps’ and ‘Local Search’ tabs are unified into a single ‘Maps’ tab in the present invention. The ‘Maps’ tab incorporates a single search box 110. Search suggestions are supported by the single search box 110 on the ‘Maps’ tab.

In accordance with the principles of the present invention, the single search server 500 is developed such that it is agnostic to the client device platform. The present invention provides support for several device platforms (e.g. android, RIM, iPhone, and Brew platforms).

The existing proxpoi servlet 520 remains untouched by the present invention (the existing protocol is backward compatible).

The inventive system of context/filter is general purpose enough to be used in a wide array of freeform, natural language queries, and may additionally be applied to new data corpuses as they become available.

The present invention has particular applicability to location-based services, mobile search services and navigation services, e.g., as provided by maps.google.com and navteq.com.

The present invention pertains to POI and address searches initiated from a single search box (i.e. a text input field), only. Meta-data concerning a nature of a search is not provided to the single search system.

The diagrams included herein are meant for illustrative purposes only.

While the invention has been described with reference to the exemplary embodiments thereof, those skilled in the art will be able to make various modifications to the described embodiments of the invention without departing from the true spirit and scope of the invention.

What is claimed is:

1. A single search system that filters search query data for context and user intent within a location based search engine, comprising:
a single search box to accept user search query data;
a single search client to filter said user search query data and display search results for said search query data; and
a search servlet to retrieve and return relevant search results for said user search query data.

2. The single search system that filters search query data for context and user intent within a location based search engine according to claim 1, wherein:
said single search box is a standalone text input field.

3. The single search system that filters search query data for context and user intent within a location based search engine according to claim 1, wherein:
said single search box is unpaired with a ‘where’ field.

4. The single search system that filters search query data for context and user intent within a location based search engine according to claim 1, wherein:
said single search box does not require meta-data identifying a search type.

5. The single search system that filters search query data for context and user intent within a location based search engine according to claim 1, wherein:
said user search query data is a point of interest (POI) search query.

6. The single search system that filters search query data for context and user intent within a location based search engine according to claim 1, wherein:
said user search query data is an address search query.

7. The single search system that filters search query data for context and user intent within a location based search engine according to claim 1, wherein:
said single search box is accessible on said single search client.

8. The single search system that filters search query data for context and user intent within a location based search engine according to claim 1, wherein:
said single search client employs a series of filter methods to progressively extract specific aspects of user intent and context from said user search query data.

9. The single search system that filters search query data for context and user intent within a location based search engine according to claim 1, wherein:
said single search client forwards said search query data and said specific aspects of context and user intent extracted from said search query data to said search servlet for relevant search results.

10. The single search system that filters search query data for context and user intent within a location based search engine according to claim 9, wherein:
said search servlet determines a data corpus to search for relevant search results based on user intent and context received with said user search query data.

11. The single search system that filters search query data for context and user intent within a location based search engine according to claim 1, wherein:
said search servlet interfaces with a APACHE SOLR™ search engine to retrieve said search results for said user search query data based on said specific aspects of context and user intent extracted from said user search query data.

12. The single search system that filters search query data for context and user intent within a location based search engine according to claim 1, wherein:
said search servlet interfaces with an advertisement provider to return an advertisement with each set of local search results returned for said user search query data.

13. A method of providing search suggestions to a single search client as text is input, character by character, into a single search box, comprising:
querying a single search server for search suggestions based on said input text;
comparing said input text to each data source part of each searchable data corpus;
determining if said input text matches a start of a word of any one or more available data source item;
determining a relevance order for said one or more matching data source items when said start of said word of any one or more available data source items matches said input text,
returning said one or more matching data source items to said single search client in a suggestions list; and
repeatedly refining suggestion candidates as additional characters are entered into said single search box.

14. The method of providing search suggestions to a single search client as text is input, character by character, into a single search box according to claim 13, wherein:
said one or more matching data source items are returned in order of relevancy.

15. The method of providing one or more search suggestions to a single search client as text is input, character by character, into a single search box, according to claim 13, wherein:
said one or more matching data source items that are geographically closer to a requesting client/user device are awarded a higher relevance score.

16. The method of providing one or more search suggestions to a single search client as text is input, character by character, into a single search box, according to claim 13, wherein:
said one or more search suggestions are point of interest (POI) suggestions.

17. The method of providing one or more search suggestions to a single search client as text is input, character by character, into a single search box, according to claim 13, wherein,
said one or more search suggestions are address suggestions.

18. The method of providing one or more search suggestions to a single search client as text is input, character by character, into a single search box, according to claim 13, wherein:
said one or more search suggestions are airport suggestions.

19. The method of providing one or more search suggestions to a single search client as text is input, character by character, into a single search box, according to claim 13, wherein:
said one or more search suggestions are point of interest (POI) category suggestions.
